(19) United States
(12) Patent Application Publication
(10) Pub. No.: US 2008/0134662 A1
(43) Pub. Date: Jun. 12, 2008

(54) Fluid Connected Heat to Motion Converter

(76) Inventors: Wayne Douglas Pickette, Champaign, IL (US); James Robert Fisher, Iron Mountain, MI (US); Gregory James Danner, Urbana, IL (US)

Correspondence Address: WAYNE D. PICKETTE, 302 S. 2ND STREET, APT. 711, CHAMPAIGN, IL, 61820-4141, US

(21) Appl. No.: 11/561,393

(22) Filed: Dec. 10, 2006

(51) Int. Cl. F02G 1/00

(52) U.S. Cl. 60/200.1

(57) ABSTRACT

My invention relates to heat engines. It has the following objectives: 1) Efficient conversion of any source of heat into useful mechanical power. 2) A novel proportional control valve system based on rotary refrigerant valves controlled by a programmable logic controller (PLC). This proportional valve system allows rapid response to any output power requirement. The PLC adjusts between energy supply and load requirements almost instantly. This also permits a servo mode implementation. 3) Uncontrolled runaway operation is impossible. Under adverse conditions, the system automatically de-powers. System integrity shall be maintained under all fault conditions unless an external force destroys the invention. 4) Internal heat storage inside the invention permits a slow rate of change for energy input. 5) The implementation of this invention provides for ease of construction from prototype to production of any size or scale. Nearly every part of this invention is composed of a round, rectangular or hexagonal flat plate, which can be easily machined or press-molded. The completed invention is comprised of a “stacked” configuration of these plates, which is then held together in slight compression by 4 (or 6) bolted studs at the corners. 6) The “working fluid” used inside this invention to convert heat into motion is a commonly available “non-ozone depleting” refrigerant. 7) The invention is comprised of a novel combination and arraignment of functional parts and details of construction, hereinafter illustrated and/or described. The device is a single cycle, short-cycle, four or six cylinder engine.

### DESCRIPTION OF DRAWINGS

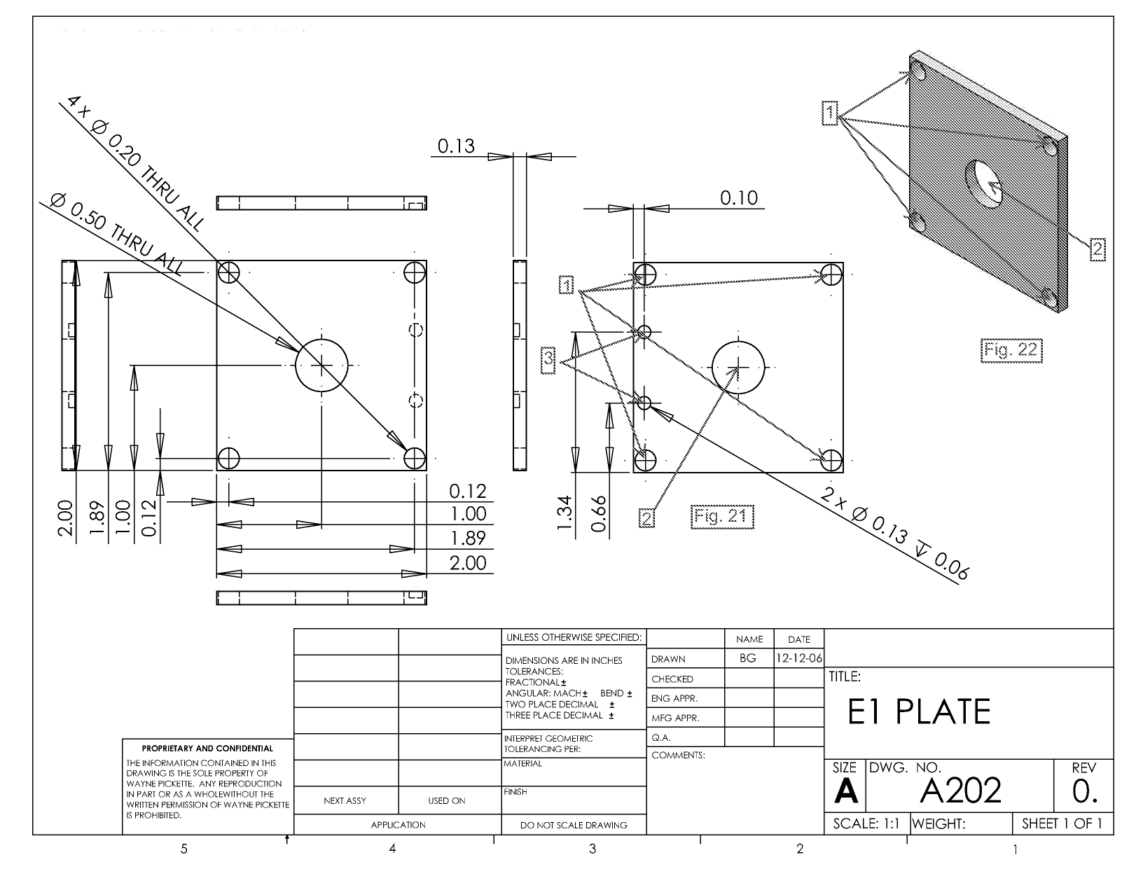

D200_Sheet1.pdf: FIG. 1, Exploded view of the invention component parts ordered as they are to be assembled ordered from right top to left bottom.

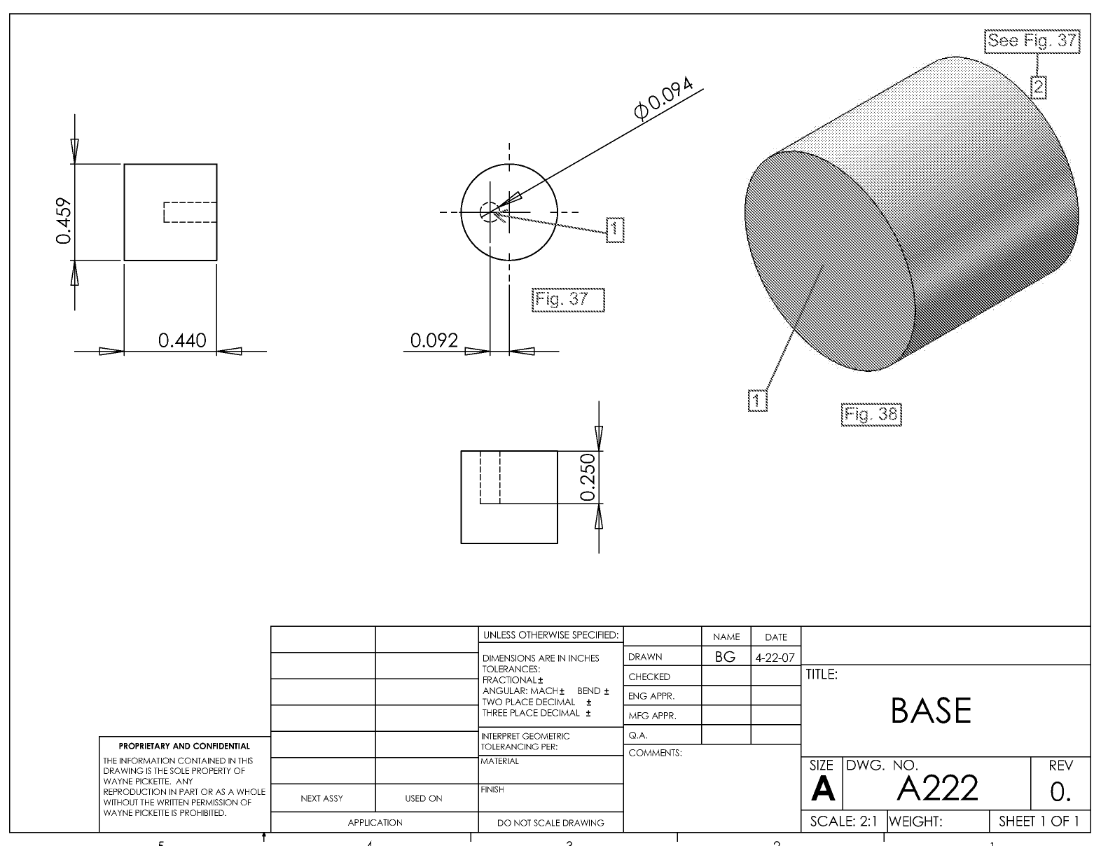

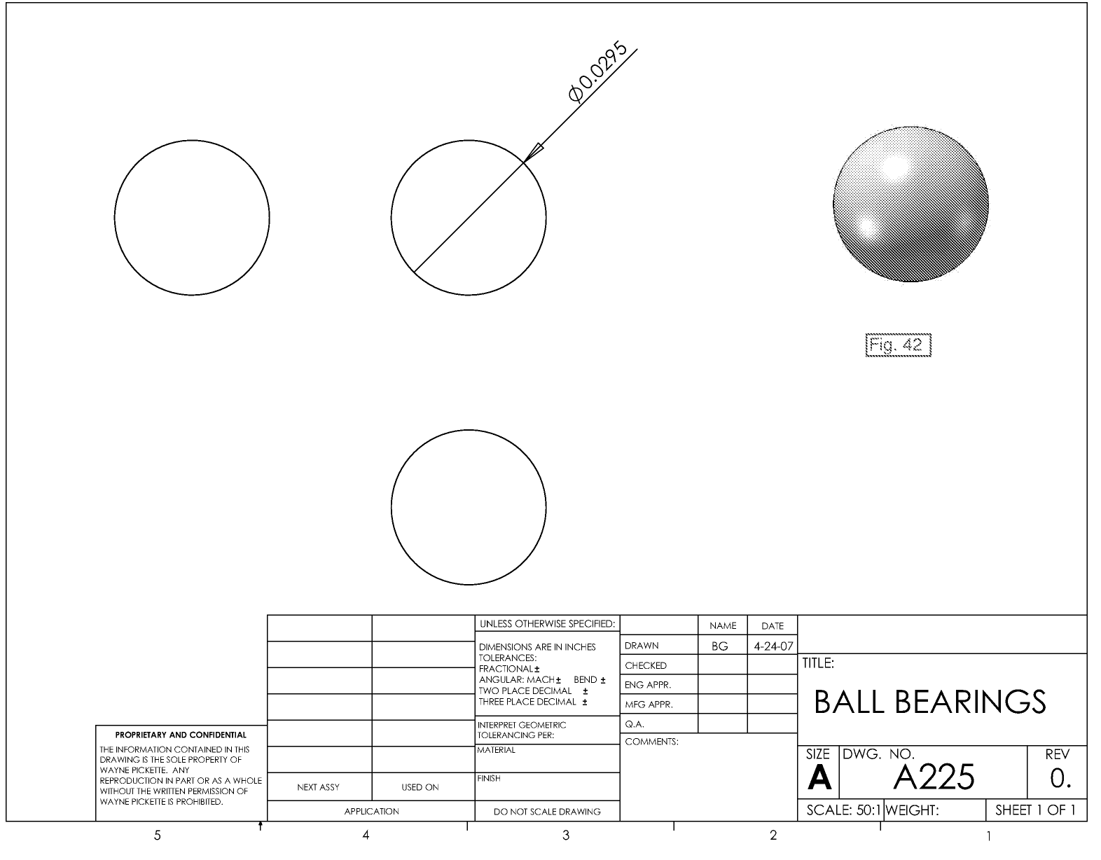

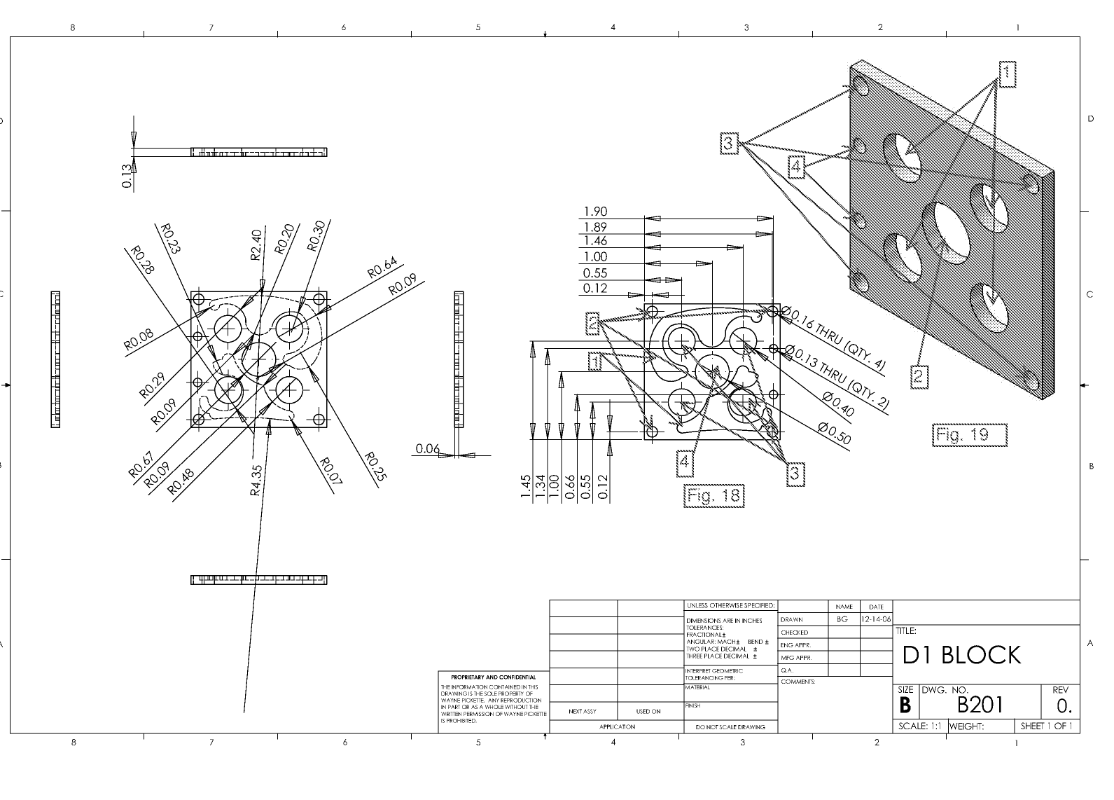

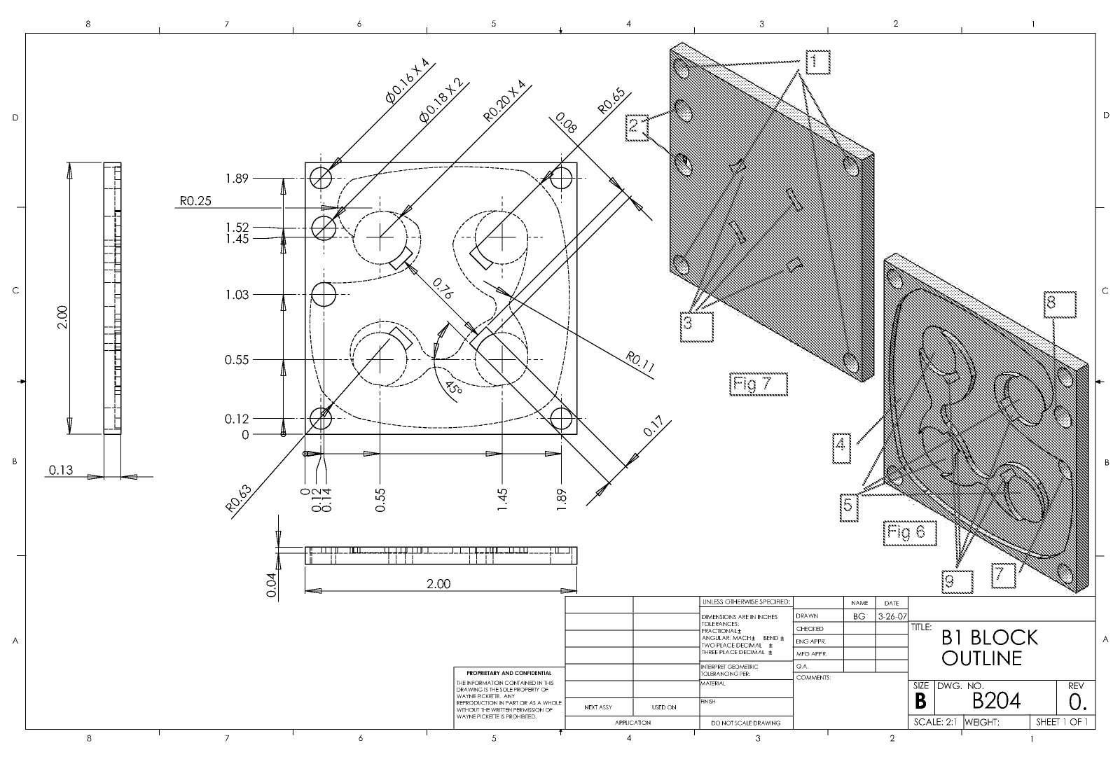

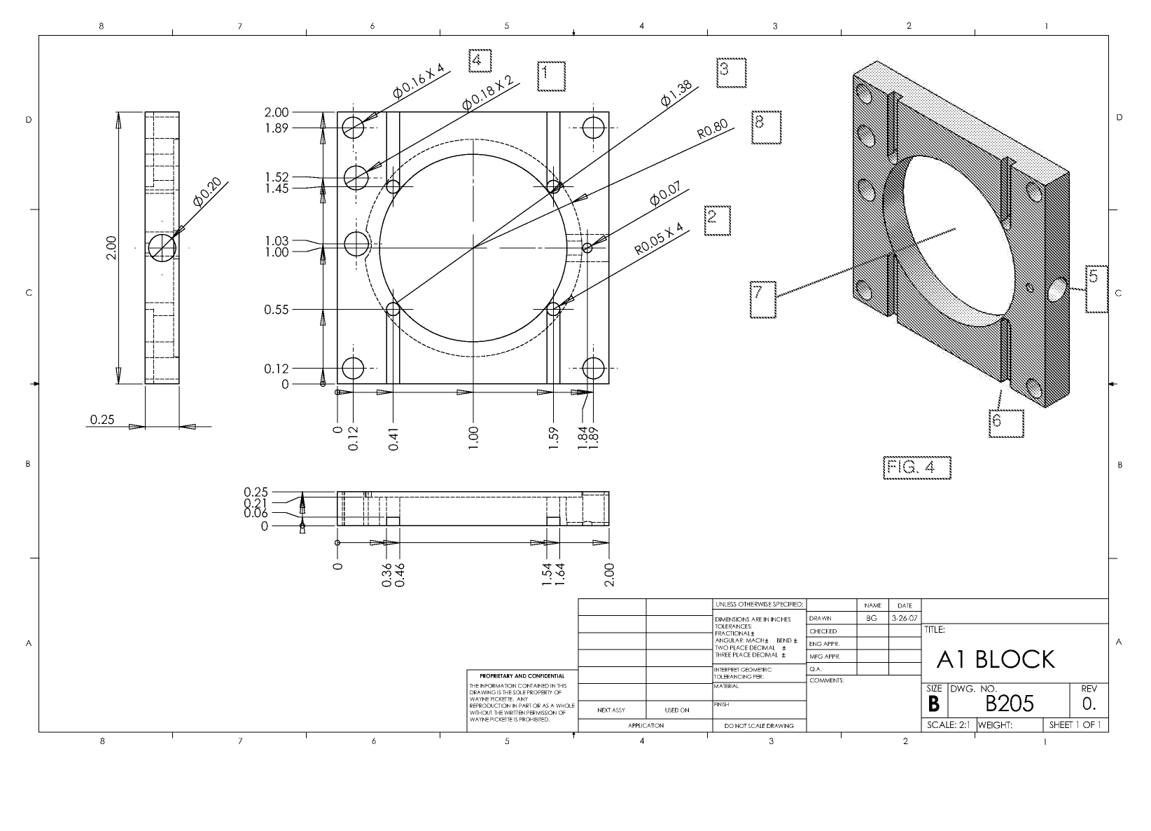

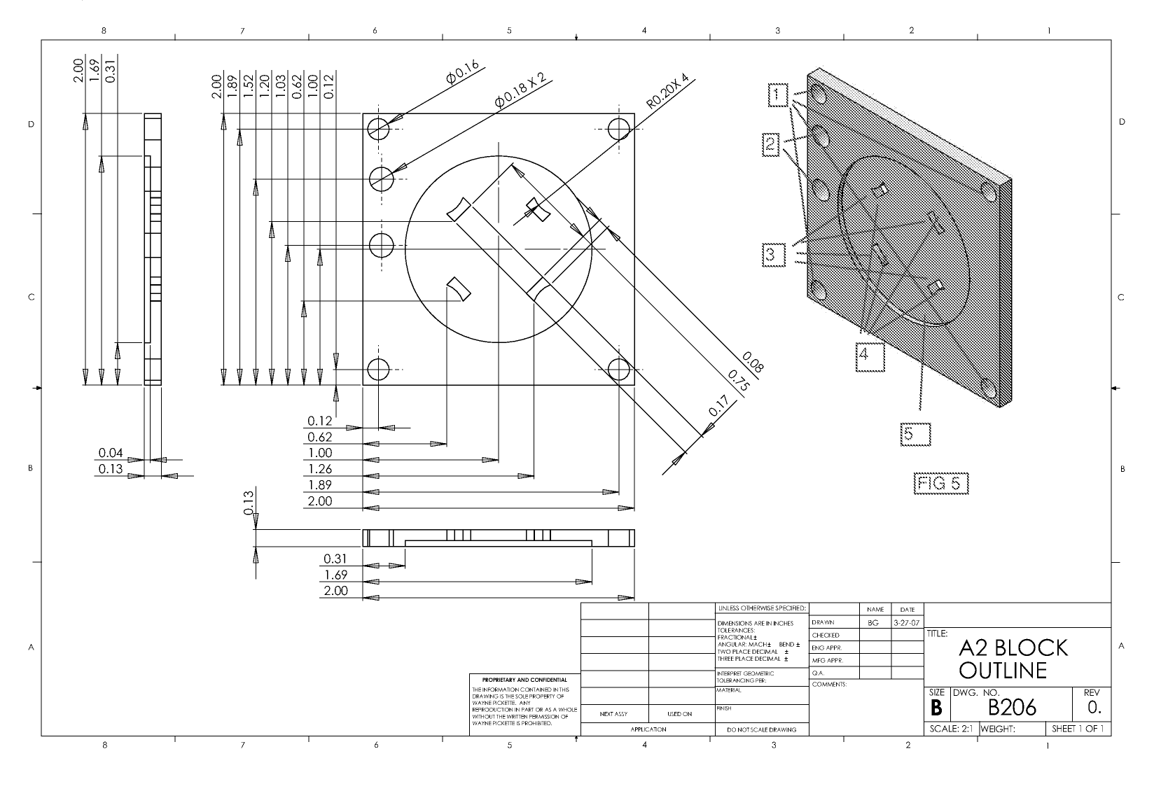

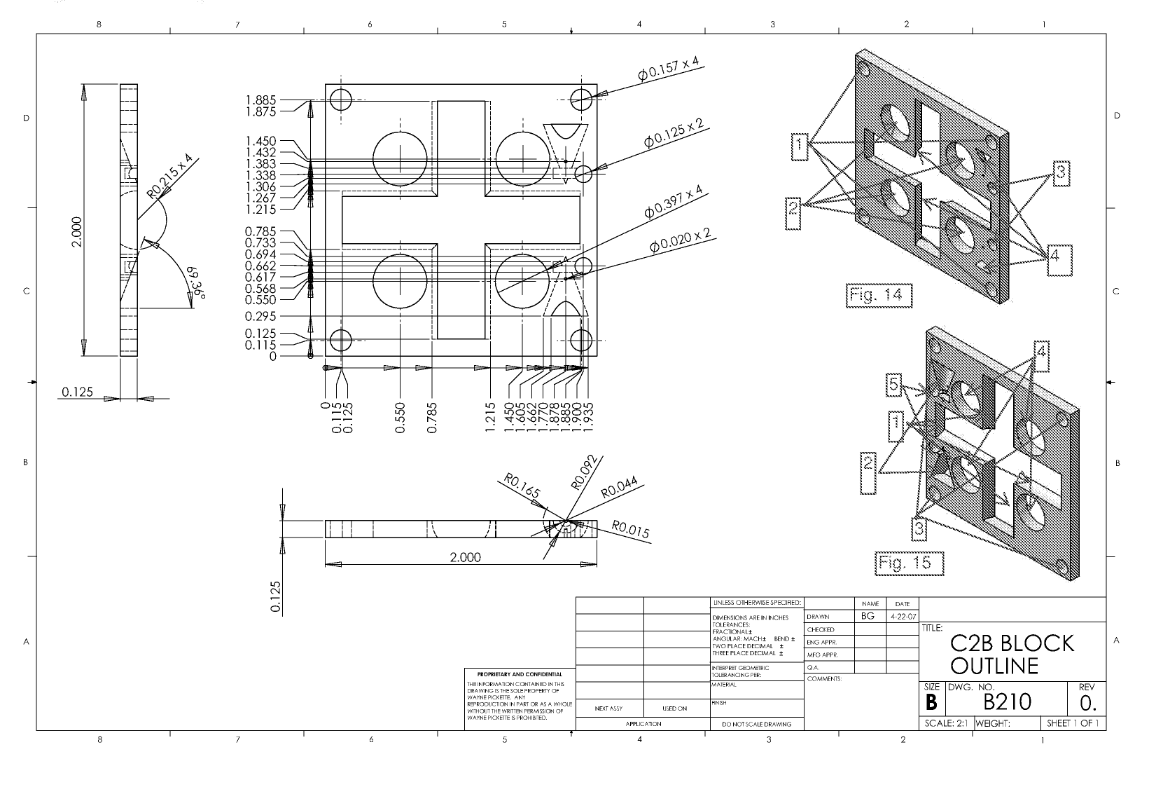

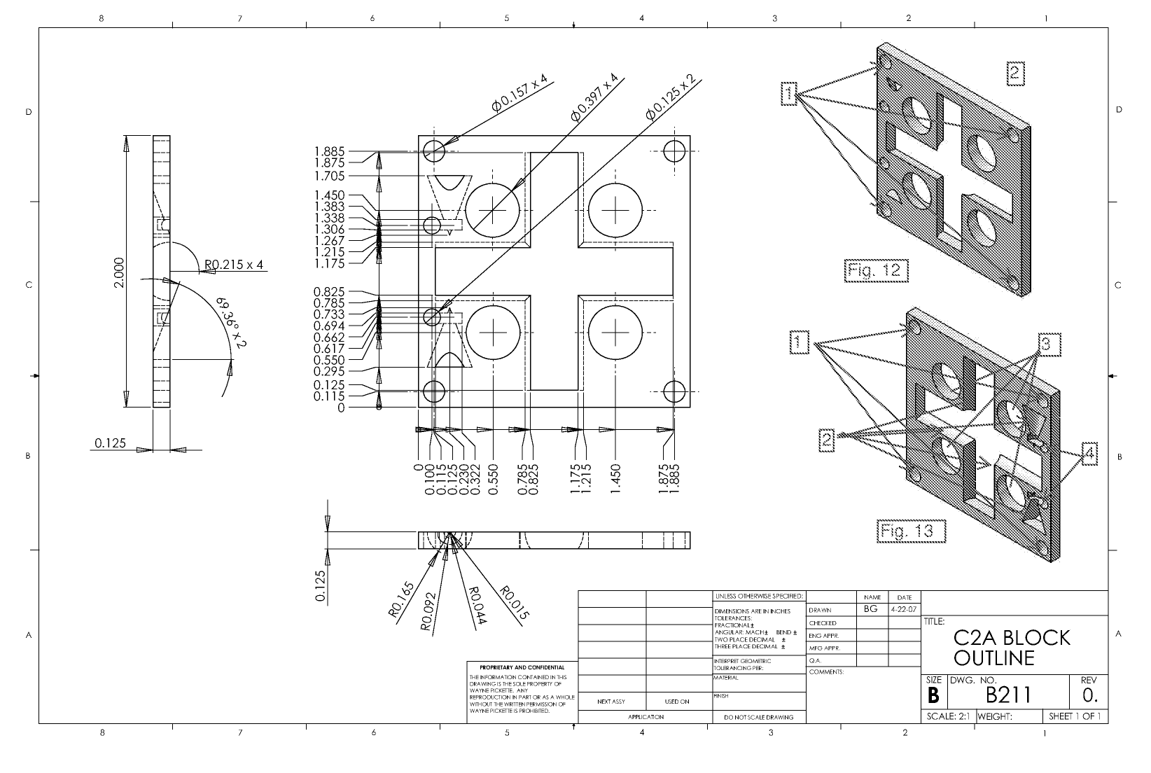

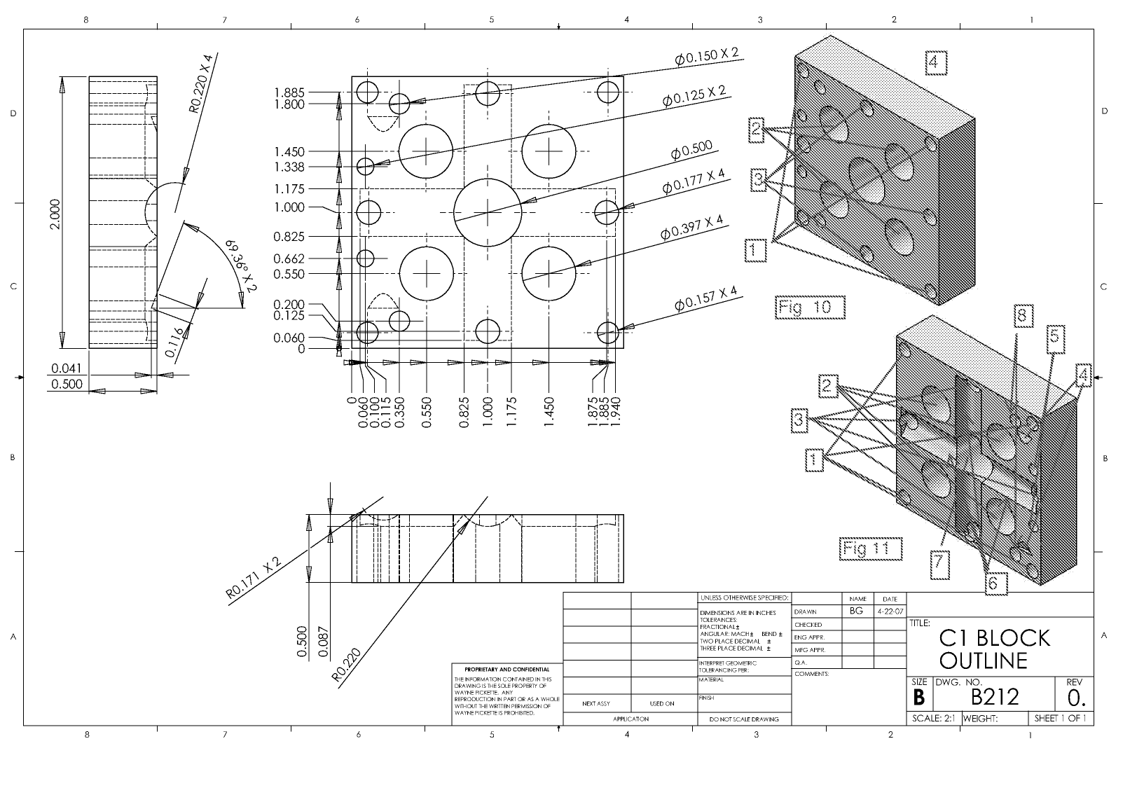

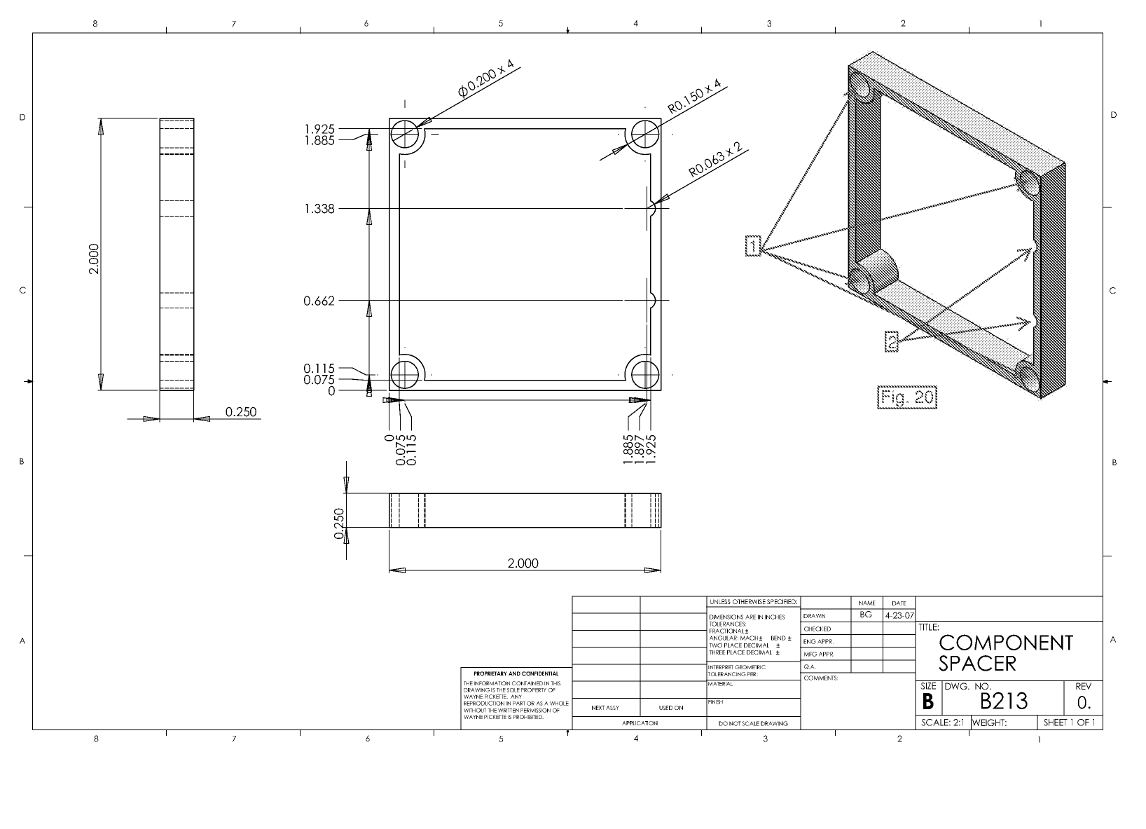

D201_Sheet1.pdf: FIG. 2, Assembled view of the invention indicating the output shaft at the top and Heat Anvil at the bottom.

B223_Sheet1.pdf: FIG. 3, The Heat Anvil is made from solid copper alloy, which serves, as the heat sink for the device. The heat anvil receives input of heat at one or several points on its construction. The device averages the temperature over the entire entity. Copper is a great conductor of heat and therefore averages the heat input into a unity temperature, which then inputs into the heat engine. This interface allows fuels to add heat at their burning temperature without compromising the operation of the heat engine. The block of copper integrates the power input over the entire component mass due to it's nature and will adopt a gradual increase in average temperature which is then directed into the heat engine. The heat anvil has three sections described from right to left. Section 1: The large-mass heat energy retention, covered in foam insulation. 2: The Turret which carries the heat energy into the general confines of the heat engine. 3: The prongs that actually enter the heat engine refrigerant storage cell area. A refrigerant droplet has cooled the concept that each prong shall rapidly return to the general temperature of the much larger turret mass after it. Therefore, the concept that the prongs due to their molecular connection to a much larger heated object shall quickly return to the temperature of the larger object follows thermodynamic laws.

B205_Sheet1.pdf: FIG. 4, Design and construction of the (A1) vapor fuel burner plate [heat source]. This is not the only possible energy source for the invention, but is representative of one method of providing caloric input into the invention. The illustrated burner plate consumes evaporated fuel to provide a caloric-input source. The illustration displays the lower surface of A1. Item (7) the large hole through which the turret of the heat anvil proceeds. Item (4) the four mounting screw holes, the two-vapor/liquid refrigerant transport holes. Shown, on the right side is the air intake hole (5) for the burner. Item to the immediate left of the air; intake hole on the bottom surface is the fuel inlet hole. Item (6) are the four slots, which allow the combuster exhaust gas to escape from the combustion ring through holes (2) then under the (A1) plate in the channels to the air. On the upper surface of (A1), he combustion ring (8) is a circular groove fed by a Schott-FP™ Cermat at the inlet to promote highly efficient confined and continuous flame burning. The Schott-FP™ Cermat, provides even complete combustion with guaranteed minimal CO NOX effluents. Four-exhaust ports (2) provide exit for exhaust gases to the free air or to a collector as necessary. The caloric transfer is by direct infrared radiation & exhaust gas convection to the Heat Anvil Turret that is immediate to the fuel combustion ring (8). Four mounting holes provided (4) in keeping with the construction of the heat engine portion of the invention. The central hole (3) is provided to allow the turret of the heat anvil to pass through to the A2 (FIG. 5) plate. Other types of heat sources, such a solar collector or geothermal heat exchanger are possible in addition to the fuel burner.

B206_Sheet1.pdf: FIG. 5, Heat Anvil mounting plate (A2). Shown, lower surface of A2. The Heat Anvil Turret seats in the bottom of A2 (5). The prongs of the metal Heat Anvil (3,4) are in communication with the heat anvil turret, which have a concave surface to interface with a valve rod. The probe is necessary to communicate caloric energy into the invention. Two holes (2) provided to communicate vapor to and liquid from the mounting plate to B1 plate.

B204_Sheet1.pdf: B1 Plate. Lower surface picture (FIG. 7). The heat anvil prongs (3) are pressed-tightly into the (B1) plate, providing a gas-tight interface. Item (1) the four mounting screw-holes, two holes (2) communicate vapor and liquid to the B1 B2 interface layer. FIG. (6), upper-surface of B1 plate refrigerant pre-evaporation cell. This is the lower part of a larger sealed area formed between the B1 & B2 plates (4). The liquid refrigerant confined inside this large gas-tight structure is passive. Valve rod seat (5) supports valve rod laterally [one refrigerant control valve rod per oscillator bank], the heat anvil probe entry (3). Evaporation of refrigerant occurs when a valve rod cup transports a droplet of refrigerant liquid 180 degrees from the adjacent pre-evaporation cell area to the evaporation cell formed by the valve rod body and the heat anvil probe (9). Liquid refrigerant arrives into the storage cell at this point (7). Refrigerant vapor is conducted to the adjacent layer inside this conduit (8).

C203_Sheet1.pdf: B2 Plate. The lower surface (FIG. 8) forms the top section of the refrigerant pre-evaporation cell (1). Drawing details: Four holes for the valve drive rods (2), which seat on the B1 layer. Item (3) four mounting-screw holes. Item (4) the vapor-transport conduits, the liquid return conduit terminates on the previous layer, the vapor conduit to the heat exchanger originates on this layer (5). At each valve rod (2) relief routing (6) guides the vapor produced into the upper B2 layer. The B2 upper surface (FIG. 9) the central shaft base (FIG. 37) seats on this layer (8). Four through holes (9) transport the valve rods to the B1 layer. The cone drive rods seat on the B2 layer (10) the exhaust vapor guided to the vapor return hole (11). Caloric reaction vapor guides route vapor to the input of each cylinder. Four through holes (7) provide for the mounting screws.

B212_Sheet1.pdf: C1 Plate. Lower surface (FIG. 10): Through-holes for mounting screws (1), in addition, through-holes for each refrigerant inlet control valve rod (2). Cylinder vapor input conduits (3) guide vapor into each cylinder. The central shaft hole (4).

Upper surface (FIG. 11): Each cylinder represented by a channel (6), which represents ¼ of the confining structure for a piston (B221_Sheet1.pdf, Fig.). In addition, ⅓ confinement is provided for both of the compressor cones (4) [B22x_{—}_Sheet1.pdf, FIG. ( )]. The through holes: for mounting screws (1). Inlet ports (3). Valve rods (2). The central shaft (7). Compressor Cone drive rod holes (5).

B211_Sheet1.pdf: C2A Plate Lower surface (FIG. 12): Through-holes for mounting screws (1), Valve Rods (2), Cone Drive Rods (3). The upper surface (FIG. 13) also contains ⅛ of the central geometry to contain the pistons and cones (1). Through holes for mounting screws (2), valve rods (3) and, cone drive rods (4).

B210_Sheet1.pdf: C2B Plate. Upper surface (FIG. 14): Through-holes for mounting screws (1), Valve Rods (2), Cone Drive Rods (3), the Cone geometry completes on this surface (4).

The Lower surface (FIG. 15) also contains ¼ of the central geometry to contain the pistons (1) and cones (2). Through holes continue the paths of the mounting screws (3), valve rods (4) and, cone drive rods (5).

B209_Sheet1.pdf: C3 Plate. Lower surface (FIG. 16): Through holes for valve rods (1). Mounting screw holes (2). Vapor pump drive shafts (3). Central output shaft second bearing surface (4), quadrant exhaust ports (5). This plate forms the upper ¼ cavity for each oscillator piston (B221_Sheet1.pdf) (6). Upper vapor pump cavities with ball track (7) (see Detail A), Refrigerant vapor pump input conduit and ports (8)

Upper surface (FIG. 17). The mounting screw holes (1). Upper surface: Conduits to buffer and direct refrigerant exhaust vapor from each of the four-oscillator quadrants (2). Exhaust ports (3) communicate to the exhaust transfer conduit (5). Through holes for each valve rod (6), Vapor Pump drive shafts (7), central power output shaft (4).

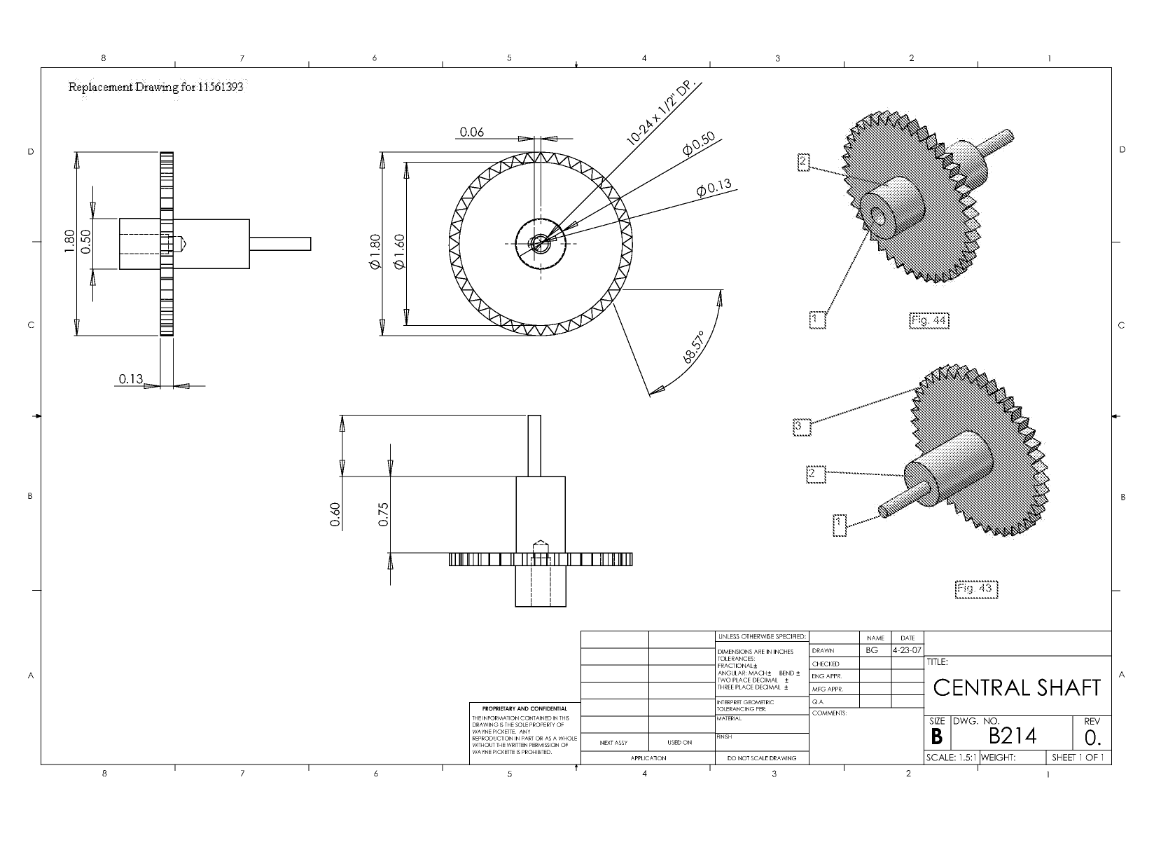

D201_Sheet1.pdf: D1 Plate Lower surface (FIG. 18): [Mirror of C3 upper surface]. This forms the remainder of the exhaust vapor routing conduits (1). This layer also provides gas-tight vapor seal surfaces for the mounting bolt holes (2), valve rods (3), Central power output shaft (4), vapor pump drive shafts (5). Upper surface (FIG. 19): Termination of the valve rods (1), the valve rod drive motors set atop this plate. These are small permanent magnet “stepper motors.” There is one drive motor for each valve rod. Through holes for the central shaft (2), mounting screws (3), cone drive rods (4).

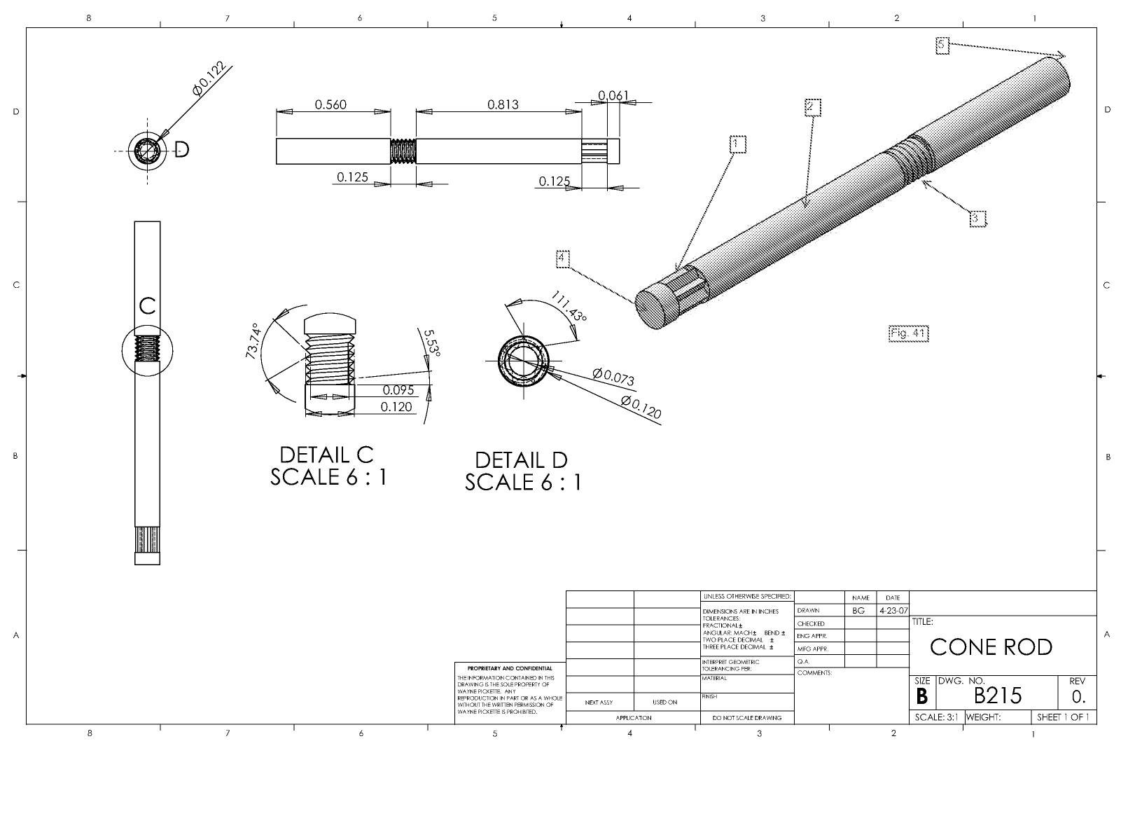

B213_Sheet1.pdf: Spacer (FIG. 20). This spacer establishes a confined space within which the interface electronics and components necessary to sense and control the device components are mounted.

Rotational index sensor electronics for the central output power shaft. A permanent-magnet dynamo style internal generator is located in this space, driven by the central power output drive shaft. This small internal electrical generator supplies operating power to the PLC and associated control electronics. Through holes are provided for the mounting screws (1). Reliefs are provided for the cone drive rods.

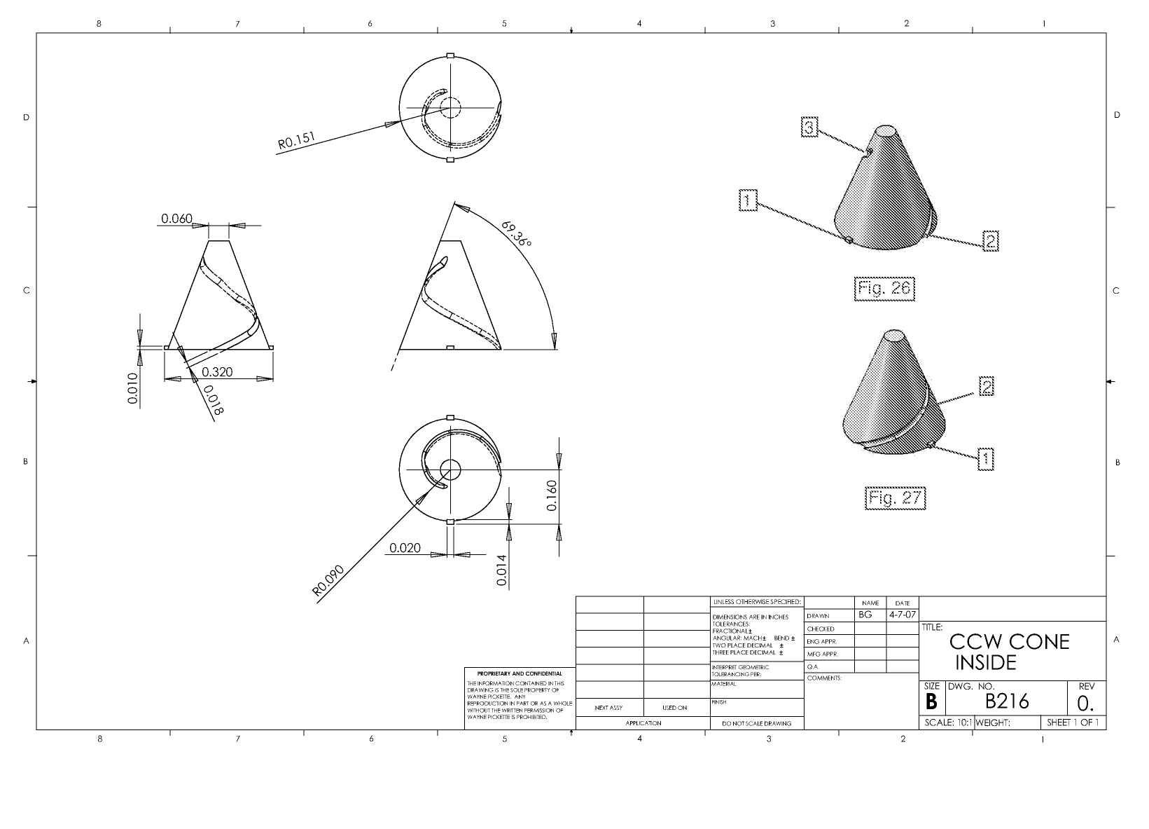

A202_Sheet1.pdf: E1 Lower surface (FIG. 21): Final layer of the invention. Vapor pump drive shafts seat into the bottom of this plate (3). A gear fixed to the central power output shaft (2) drives smaller gears, which cause the vapor pump drive shafts (3) to rotate. The top surface (FIG. 22): The entire plate assembly is held together by the mounting screws (1), which terminate on the upper surface of the plate. A large bearing surface (2) provided for the central output power shaft that insures the stability necessary for a lengthy mechanical life.

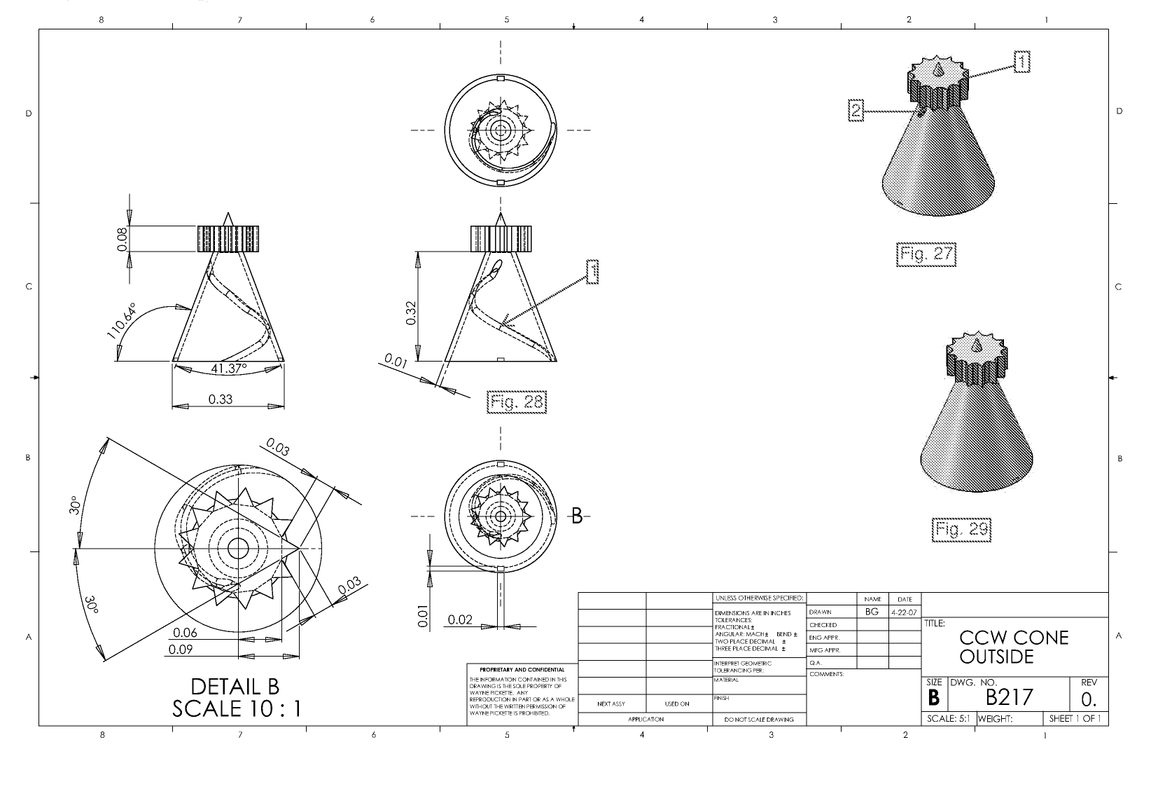

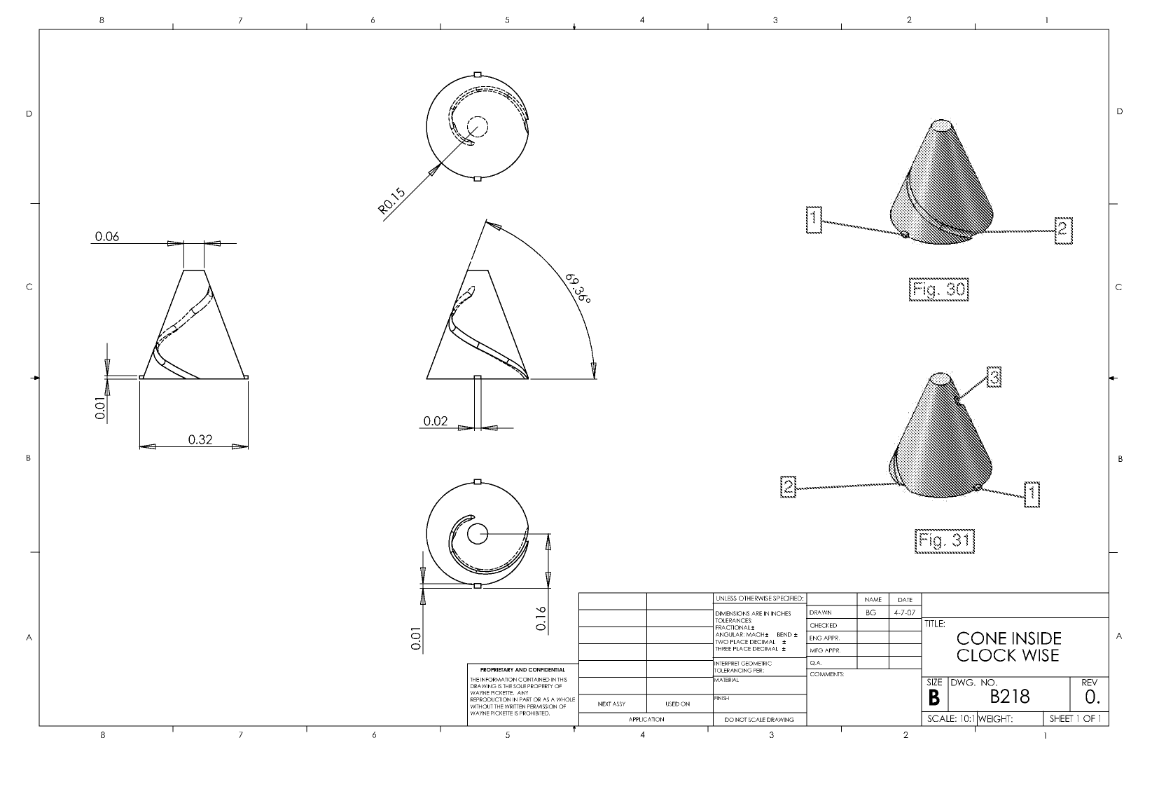

D207_Sheet1.pdf: Mounting Plate A, Upper surface (FIG. 23): The hole for turret of heat anvil (1), The mounting screws (2). Shown, vapor & liquid lines (3). Shown fuel feed hole (4). On the opposite, end the vapor fuel inlet (5). The heat exchanger input (6), the heat-exchanger output (7). The lower surface (FIG. 24): Through holes, the mounting holes (1) and heat anvil turret (2). There is routing to form a conduit for the vapor and fuel components (3). The vaporized refrigerant is routed from the vapor conduit (4) to the heat exchanger input (5). Returning liquid refrigerant is routed from the heat exchanger output (6) to the liquid refrigerant conduit (7). The vapor fuel is routed from the input (8) to the fuel conduit (9).

D208_Sheet1.pdf: Mounting Plate B, Upper surface (FIG. 25): Through hole for the heat anvil turret (1). The mounting screw holes have threaded inserts to attach the mounting screws securely (2). There is mirrored routing to match the lower surface of mounting plat (FIG. 23), (3).

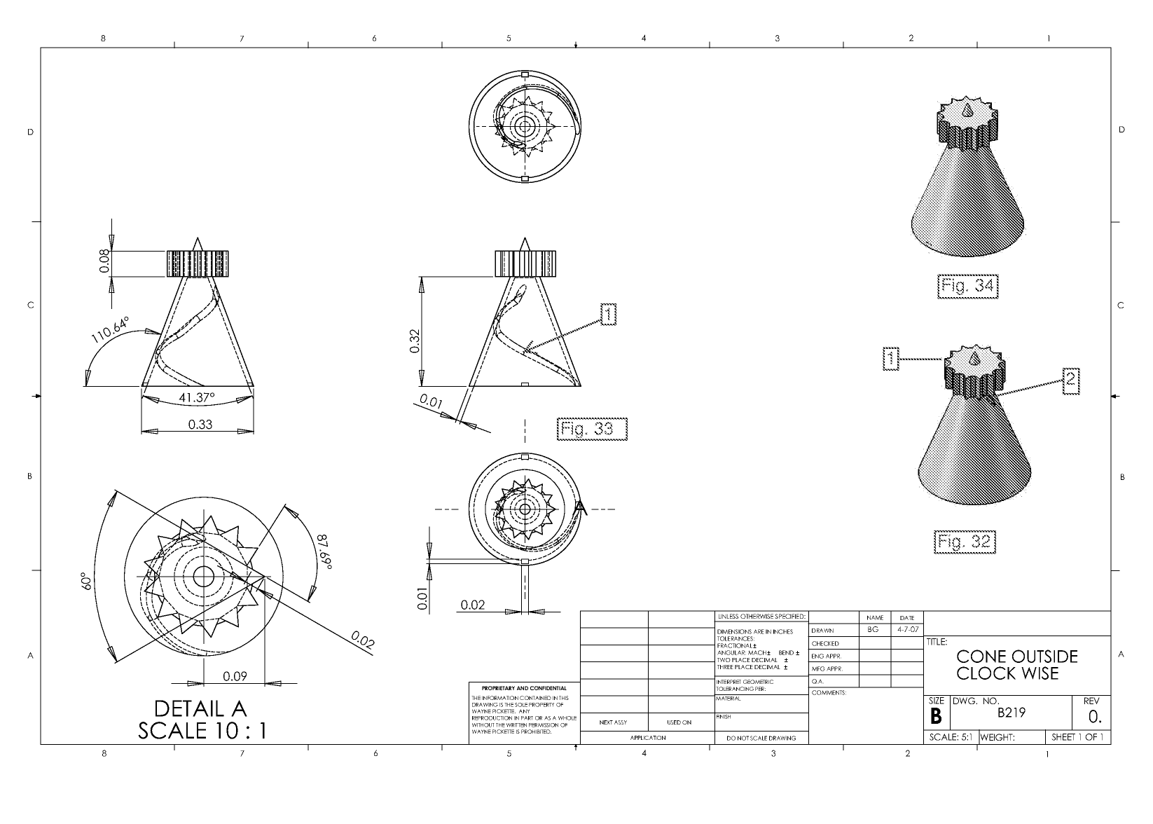

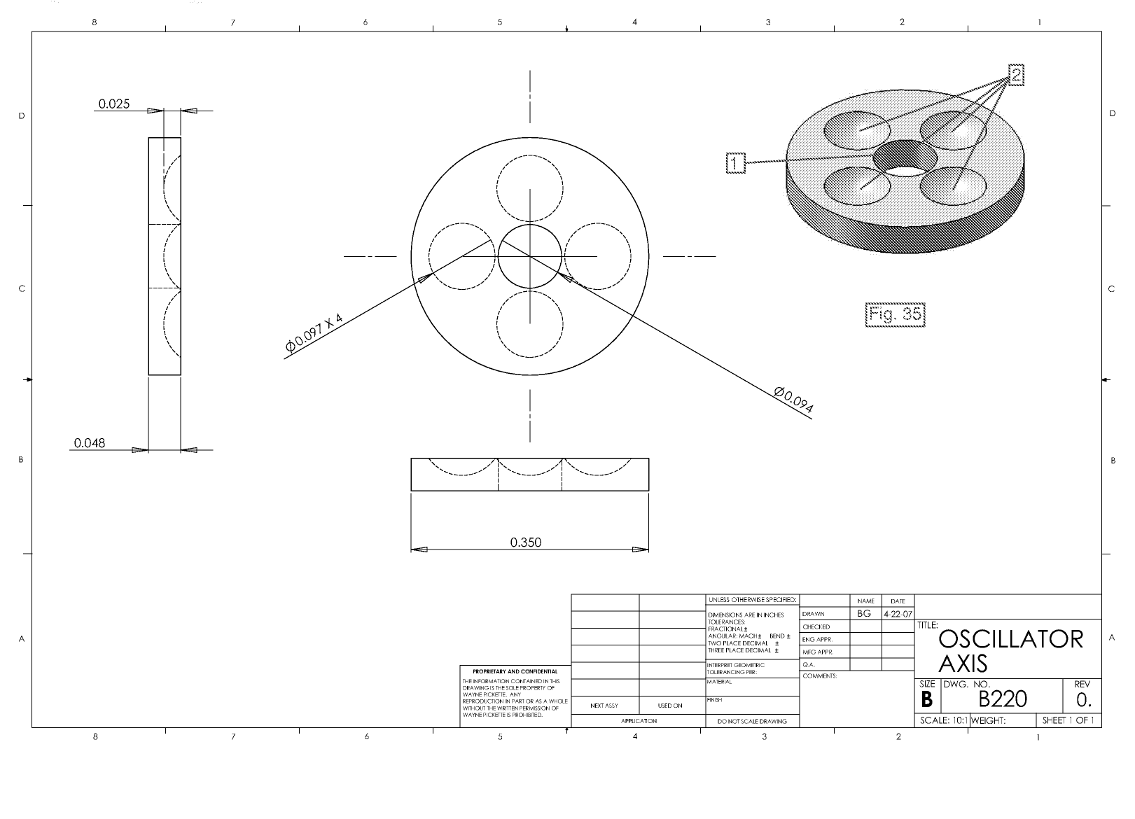

B216_Sheet1.pdf: CCW Cone Internal: Counter-Clockwise Internal Cone. One-half (0-180 degrees) of the cone is illustrated (FIG. 26) indicating the index tab (1), the beginning of the geometrical track (2) designed to allow centrifugal force to push the ball in the track forcing compression. The final portion of the track is illustrated (3). One-half (181-360 degrees) of the cone is illustrated (FIG. 27) indicating the second tab (1) and the remaining portion of the track (2).

B217_Sheet1.pdf: CCW Cone Outer: Counter-Clockwise External Cone. One-half (0-180 degrees) of the cone is illustrated (FIG. 27). The gear to interface with the cone drive rod (1). The exit hole (2) for balls then the balls encounter the track built into the bottom surface of C3 (FIG. 16) to be in sequence re-inserted into the track-pushing vapor in front of it. The cone has an internal track (FIG. 28), (1) to match the track in the inner cone. The two pieces form a completely circular channel for the balls to navigate. The remainder of the cone (FIG. 29) is without special consideration.

B218_Sheet1.pdf: Cone Internal: Clockwise Internal Cone. One-half (0-180 degrees) of the cone is illustrated (FIG. 31) indicating the index tab (1). The beginning of the geometrical track (2) designed to allow centrifugal force to push the ball in the track forcing compression, then end of the track (3). One-half (181-360 degrees) of the cone is illustrated (FIG. 30) indicating the second tab (1) and the beginning portion of the track (2).

B219_Sheet1.pdf: Cone Outer: Clockwise External Cone. One-half (0-180 degrees) of the cone is illustrated (FIG. 32). The gear to interface with the cone drive rod (1). The exit hole (2) for balls then the balls encounter the track built into the bottom surface of C3 (FIG. 16) to be in sequence re-inserted into the track-pushing vapor in front of it. The cone has an internal track (FIG. 33), (1) to match the track in the inner cone. The two pieces form a completely circular channel for the balls to navigate. The remainder of the cone (FIG. 34) is without special consideration.

B220_Sheet1.pdf: Oscillator Plate: The oscillator plate (FIG. 35) is used to secure the piston ends then to interface the entire assembly to the main-shaft pin. Features are: Hole for the main-shaft pin (1), ¼-bowls (2) where piston balls (FIG. 36) are retained when two (FIG. 35) plates are placed together with the four individual ball ends of the pistons.

B221_Sheet1.pdf: Piston: The piston (FIG. 36) is the second operative within the engine. The forward edge is rounded (1) to facilitate angles in the cylinder during complex motions due to the offset of the main-shaft pin and the common oscillator plate arrangement. The triangle (3) body shape is to take the most advantage of strength provided through linear angles. The ball (2) interface allows multiple axis of movement.

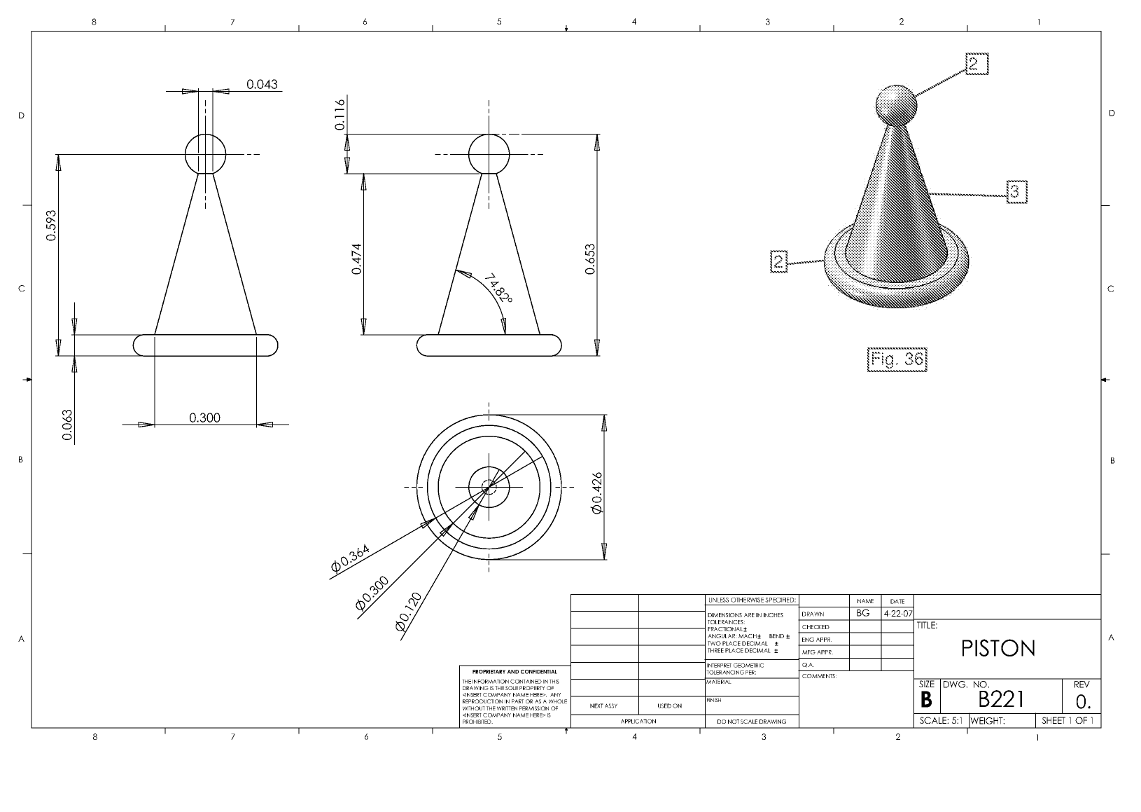

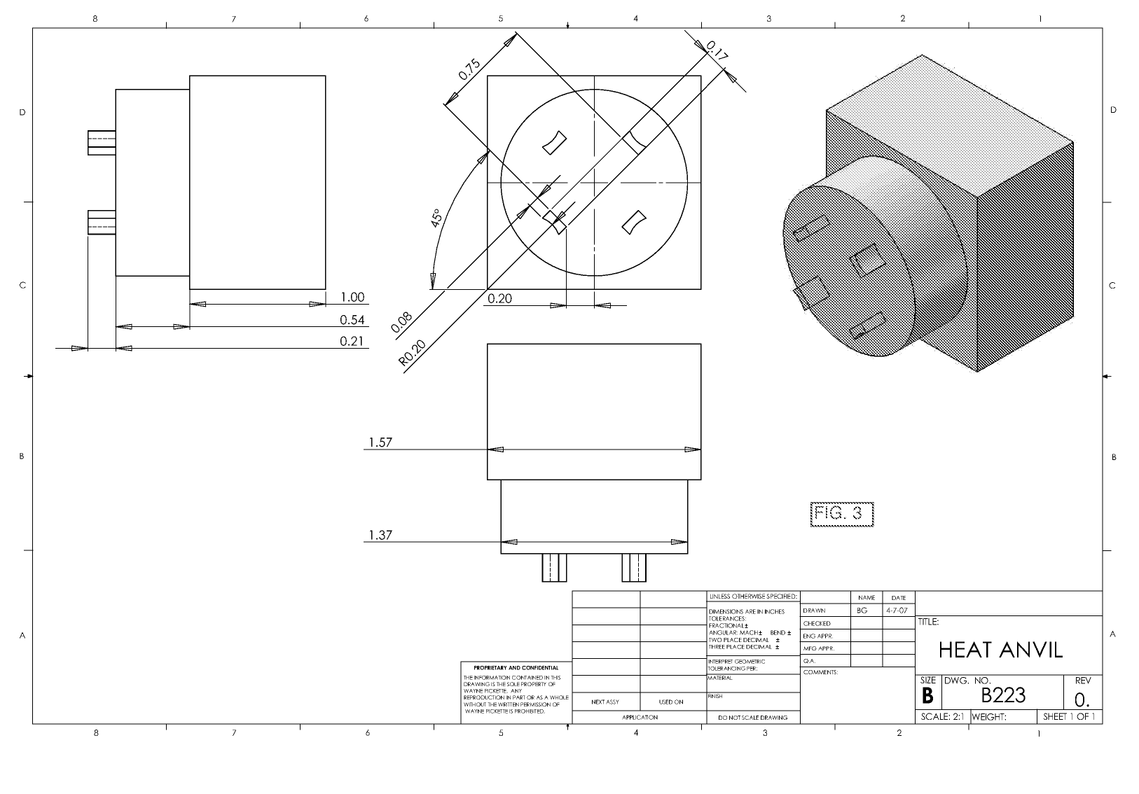

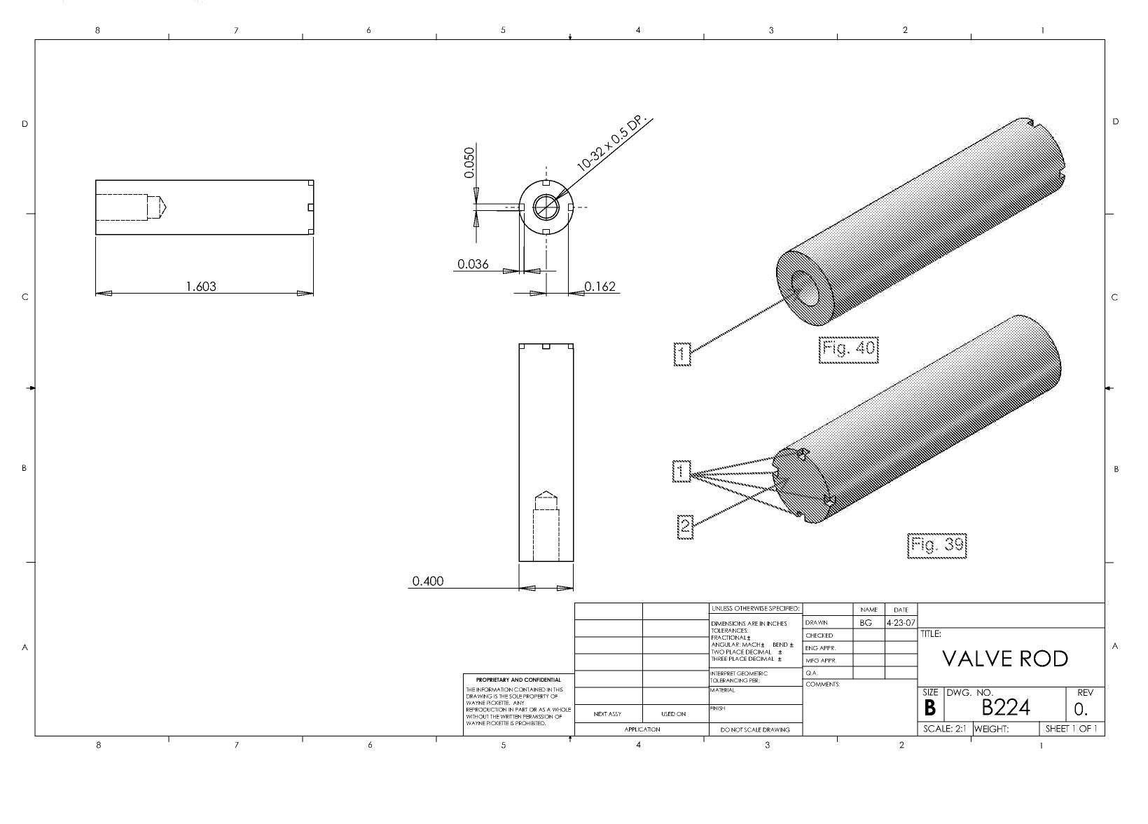

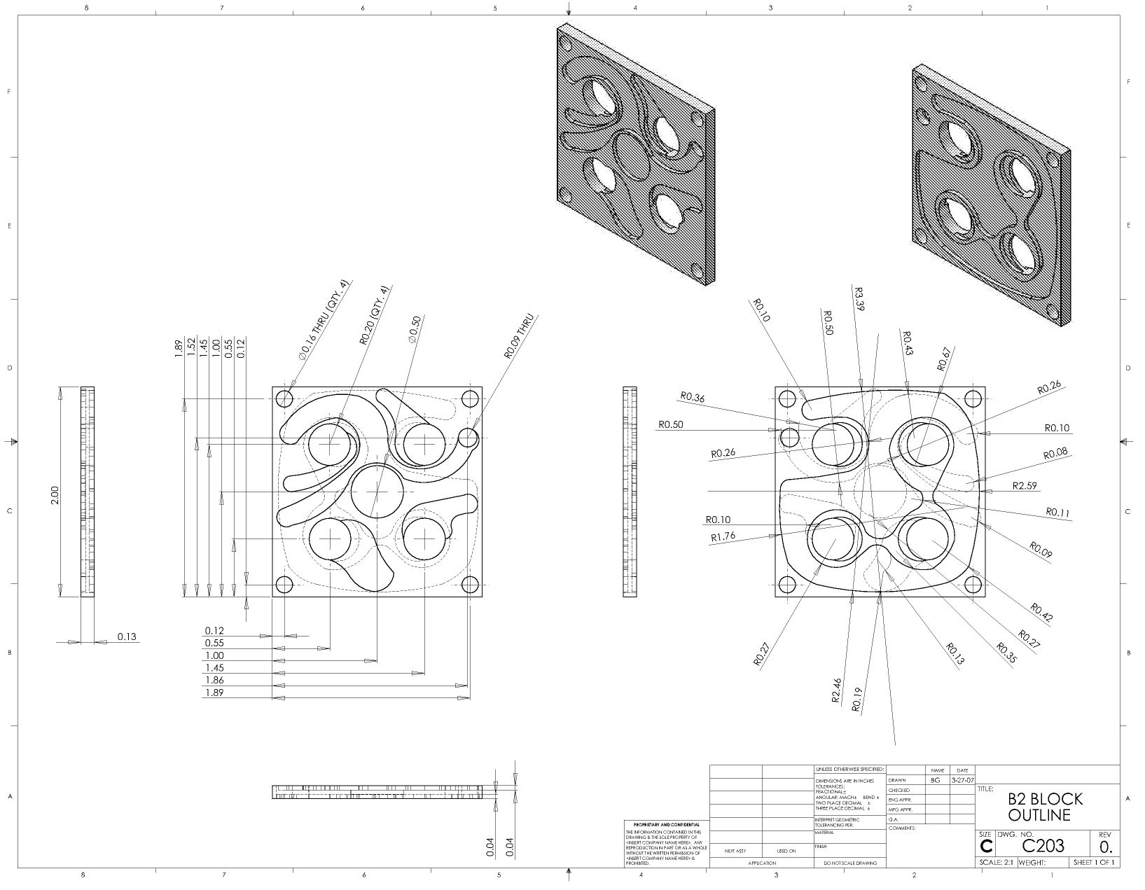

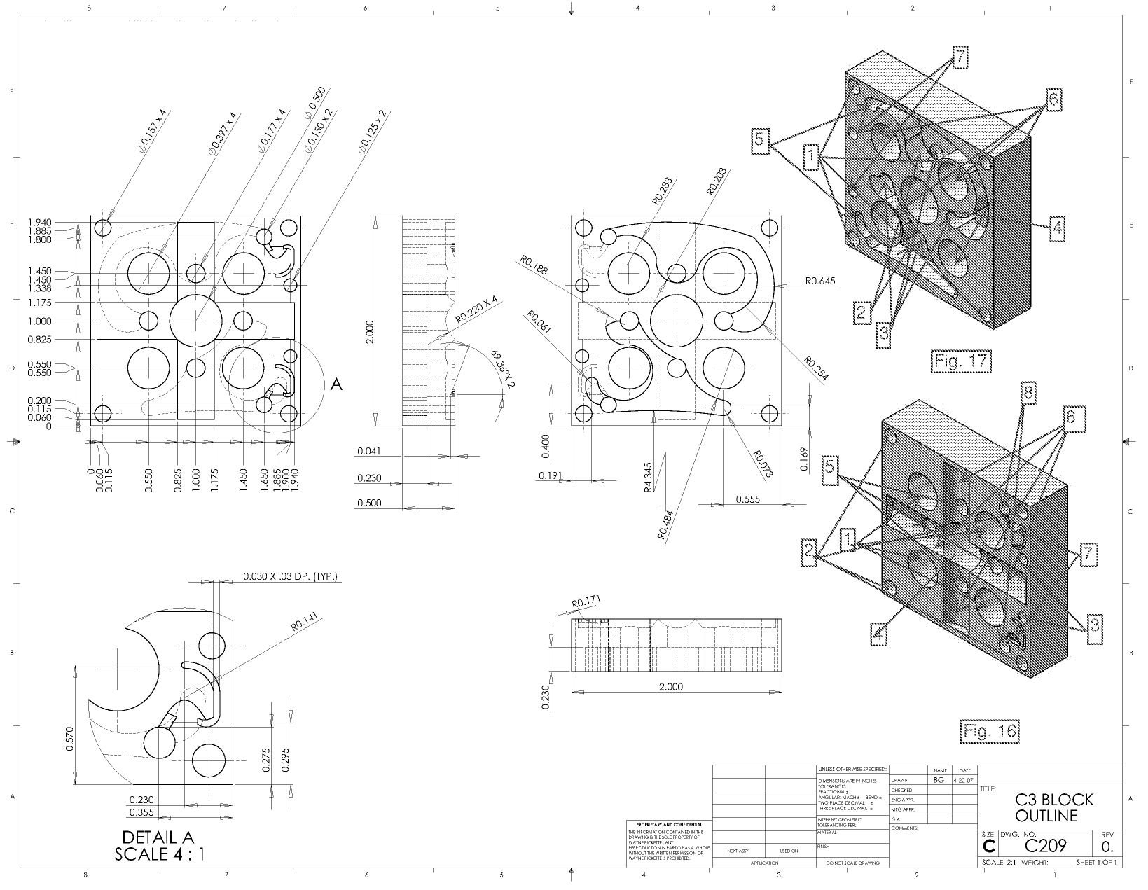

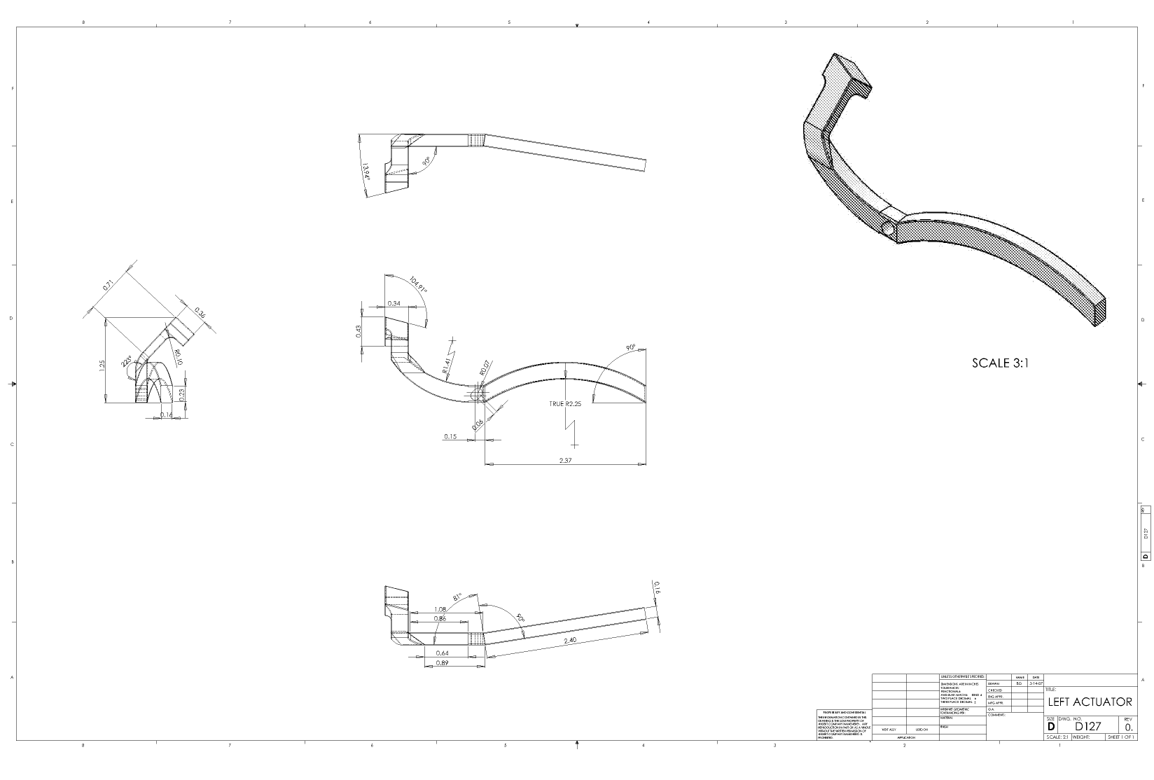

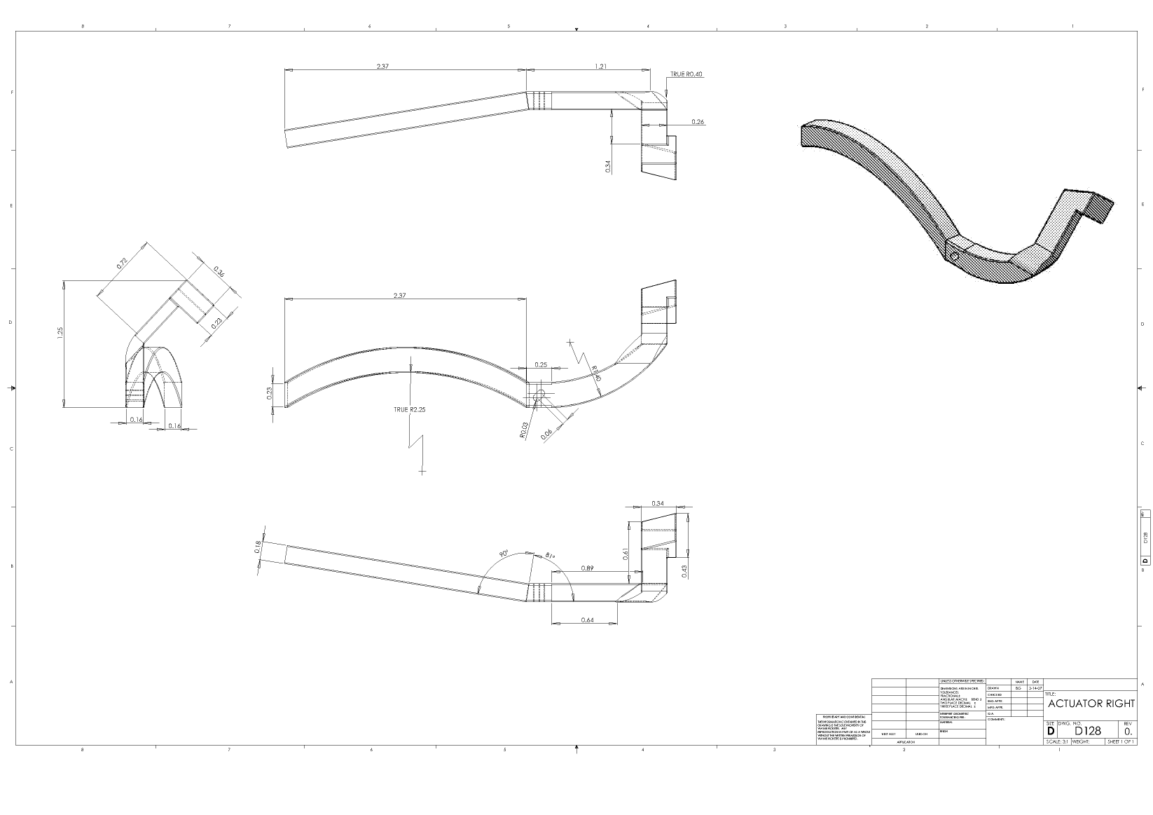

A222_Sheet1.pdf: Main Shaft Base: The main shaft base (FIG. 38) supports the bottom oscillator plate (FIG. 35) on it top surface (2). The base is intersected by the main-shaft pin (FIG. 37), (1) which aligns the base and turns the base on it's axis to follow the main shaft. The bottom of the main shaft base (1), seats into the area provided on the B2 plate (FIG. 9).

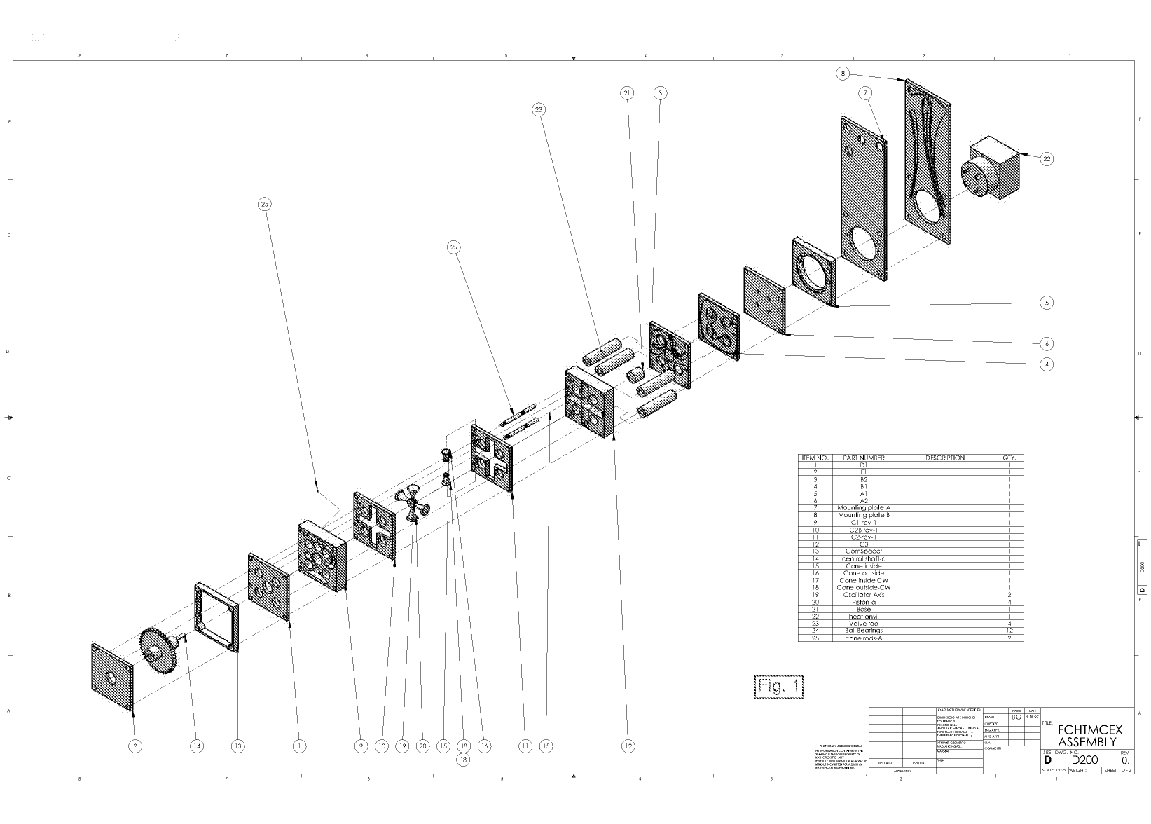

B224_Sheet1.pdf: Valve Rod: The valve rod (FIG. 39) is the metering dispenser unit in the engine. When the valve rod is spun, every 90 degrees a well (1) transports a droplet of liquid refrigerant from the pre-evaporation (FIG. 7 & FIG. 8) cell to the evaporation cell. The valve rod and the heat anvil probe (FIG. 3) which is present in the construction in the B1 & B2 plates form the evaporation cell. The droplet boils to vapor which enter the channel on B2 uppers surface to enter the associated cylinder.

The top end of the valve rod (FIG. 40) contains a 10/32 thread insert (1) to allow secure attachment of the magnet assembly used to provide rotation of the valve rod.

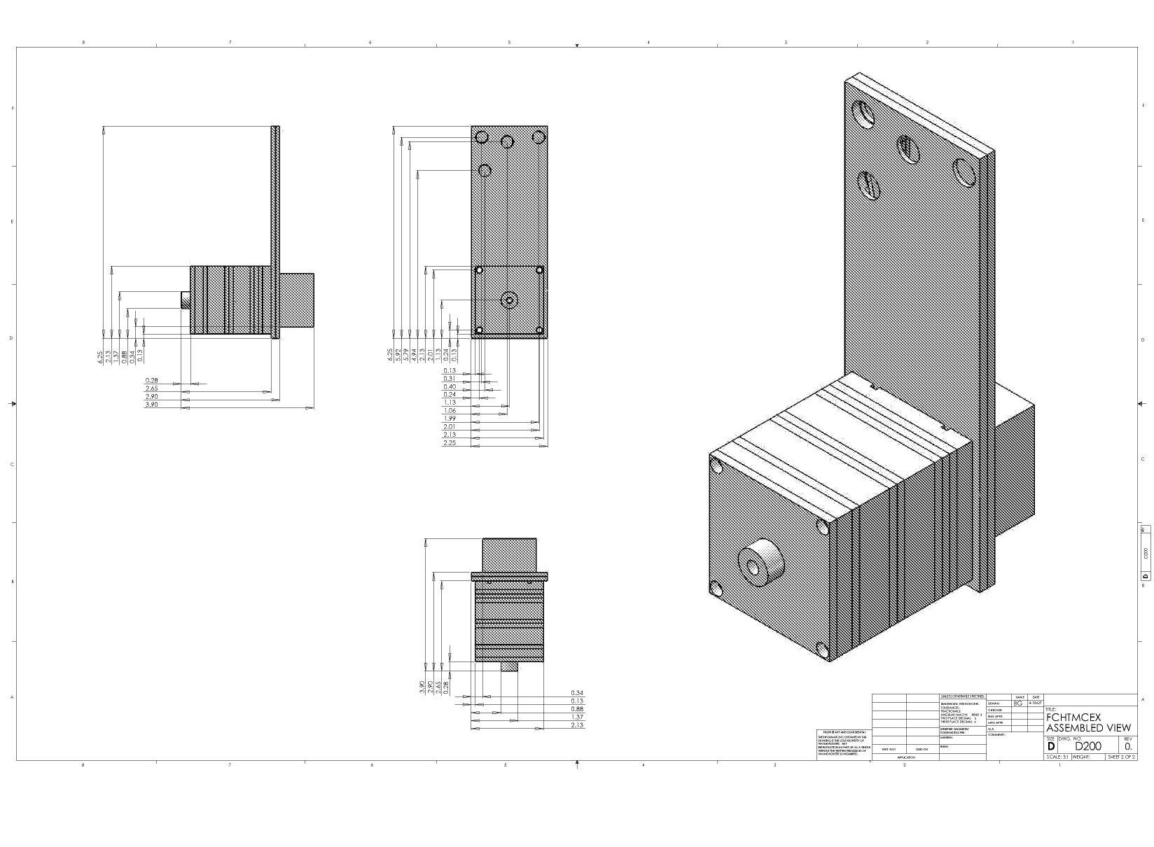

B215_Sheet1.pdf: Cone Drive Rod: The cone drive rod (FIG. 41) transfers energy from the spur gear (FIG. 45) on the main shaft to the cone compressor (FIG. 27 & FIG. 28). The gear provides thrust to the rod gear (1) that then rotates the spiral gear (3) to turn the gears on the outer compressor cones (FIG. 27 & FIG. 32). The top (4) of the cone drive rod seats into the bottom of the E1 plate (FIG. 21). The bottom end (5) of the cone drive rod seats into the B2 (FIG. 8) upper layer.

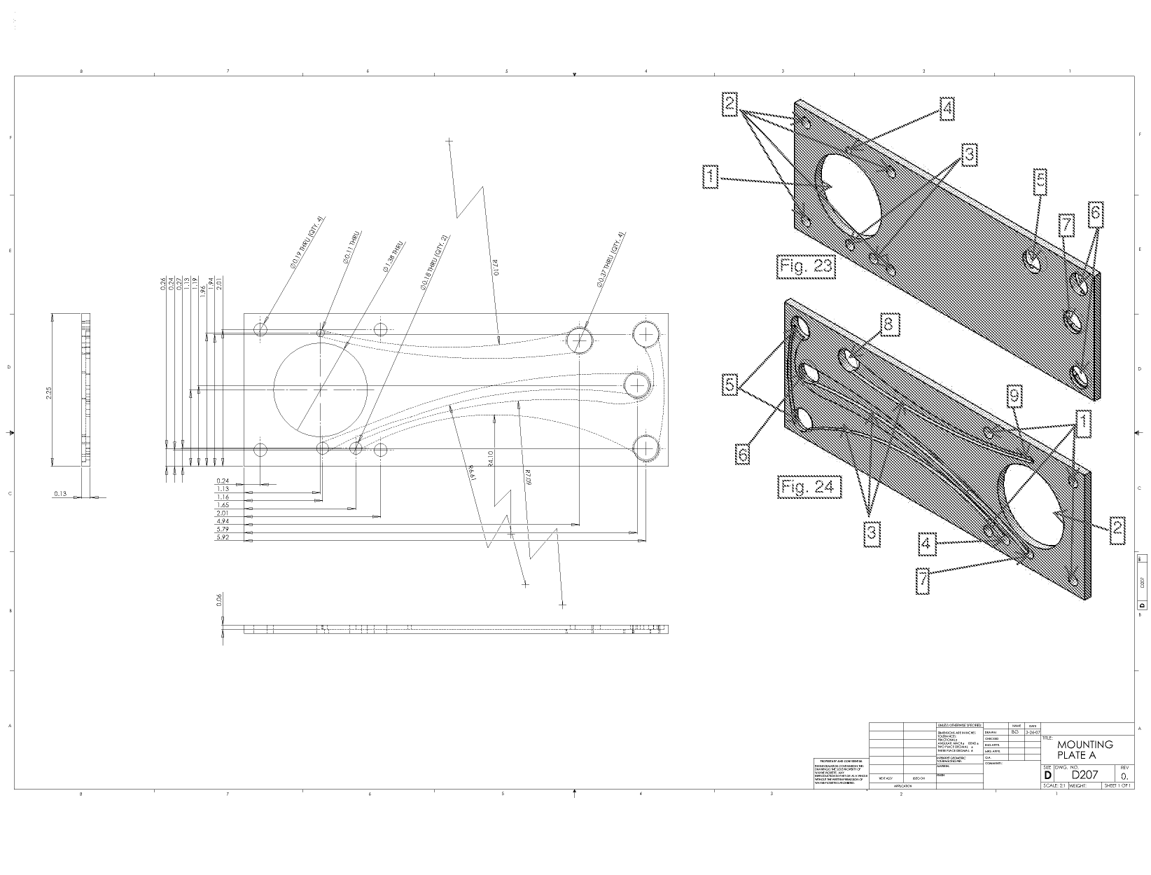

A225_Sheet1.pdf: Cone Ball: Cone balls (FIG. 42) are the centrifugal compressor agents in the cone compressors. As their density is higher than that of the vapor, the ball assisted by centrifugal force pushes the vapor in front of it to the exit hole causing a high-pressure stream of vapor to exit. The faster the engine turns the high the speed of transfer and of pressure of the vapor stream. A direct relationship!

B214_Sheet1.pdf: Central Shaft: The central shaft bottom view (FIG. 43) central-shaft transfers rotational energy from the oscillator to the internal components and to work outside. The pin (1) fits into the hole on the oscillator plate (FIG. 35) then into the main shaft base (FIG. 38). The base of the shaft (2) presses onto the top oscillator base holding it secure. The gear (3) transfers energy to the cone compressor drive rods.

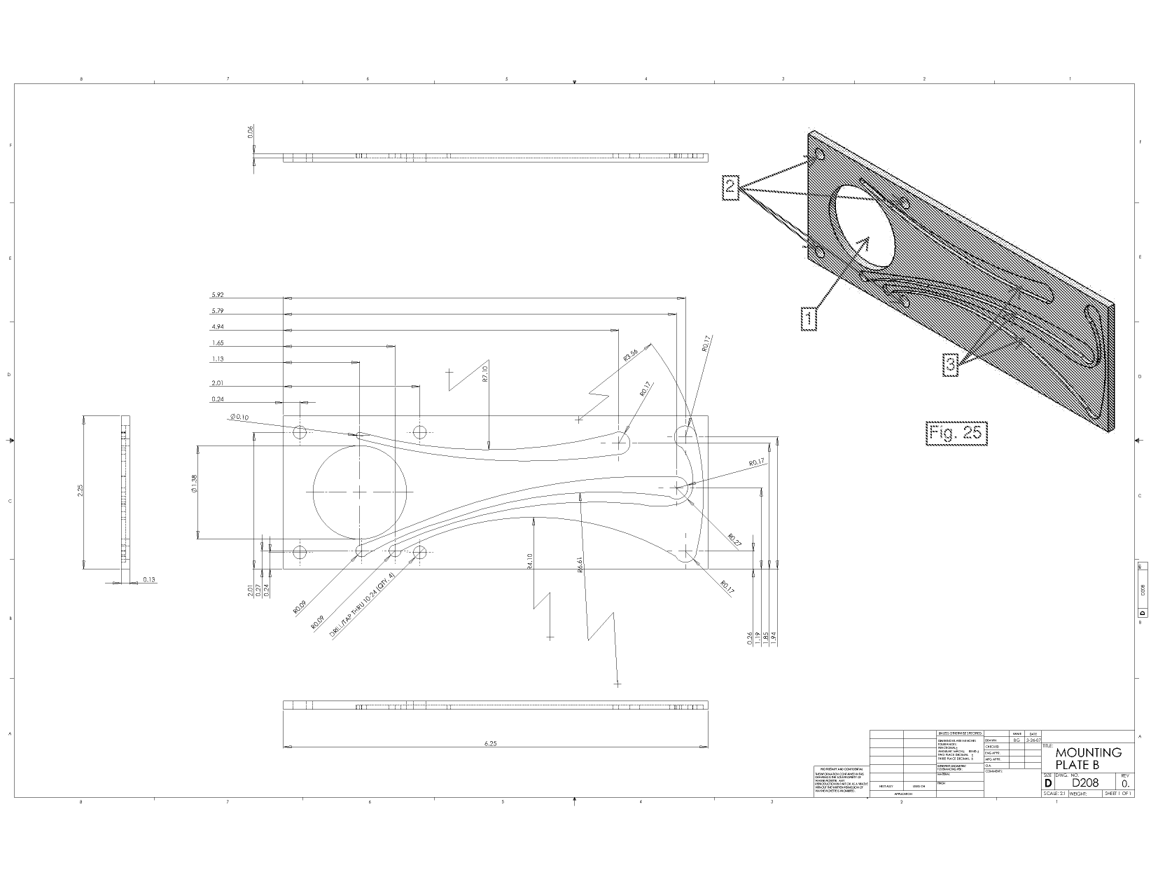

The central shaft top view (FIG. 44) displays the final bearing surface (2) combines with the E1 plate (FIG. 22) to steady the main shaft. A 10/24-screw insert (1) provides for attachment of various pulleys and chains or direct coupling.

The entire construction scheme shown in these drawings consists of a multi-layer stack of square or hexagonal plates of varying thickness. This “stacked plate” construction technique results in a final assembly containing all the functions of the mechanical components of the “Fluid coupled Heat to Motion Converter.” The heat anvil is located at the bottom of the stack and the power output shaft is located on the top of the stack and the waste heat exchanger are located at the side of the near or far side of the stack.

Assembly of the Invention:

The heat anvil must be placed through the mounting plate; then the A1 gaseous fuel burner must be placed over the heat collector, then the A2 lower refrigerant cell plate must be installed, then the B1 upper refrigerant cell plate must be installed, then the B2 vapor control plate must be installed. Next, the C1 manifold plate is installed, then the C2 oscillator cavity plate must be installed, then the oscillator is placed with the index protrusion inserted into the quadrant 00 position. The C3 exhaust manifold plate must then be installed, next the vapor pump cones complete with balls must be installed be sure to place the proper cone in each position, then the eccentric prong of the central output power shaft must be inserted into the oscillator it seats into B1, then each valve rod, aligned with the index in home position must be installed. Next, the D1 quadrant exhaust/vapor pump input manifold plate must be installed, then the magnet heads must be installed onto each valve rod with the index at home position, then the D1 spacer must be installed, then the vapor pump drive gear must be installed, then the E1, containment plate must be installed, then the four mounting bolts are pushed down through the plates and are tightened to approximately 25 ounce inches of torque. Finally, the heat exchanger must be installed onto the mounting plate.

All of the above plates and components in the prototype of the invention are constructed of machined (drilled, milled, ground, and polished) MACOR™ material, a product of Corning Glass. These components of the invention may also be press-molded from Z500™, a sister product of Morgan Advanced Ceramics. The usage of these materials to construct this invention is due to their unique properties: Zero grain, very low thermal conductivity, high dimensional stability, high flexural strength, extreme hardness (toughness), and shock resistance. A known fact that an AA grade surface finish may be obtained on any surface of these materials by the appropriate grinding and polishing. Mated AA surfaces have two properties, which are essential within this invention: 1) Practically zero friction, 2) Gas-tight vapor seal. In construction of the prototype and in production, grinding and polishing of specific areas to an AA-grade surface finish is necessary. The exploded component views note those surfaces where the AA-grade finish is required.

To provide a backup gas-tight vapor seal, a self-priming silicone adhesive is placed into circumventing grooves cut into each plate of the invention. After assembly and curing of the adhesive, a vacuum of 25 cm is pulled through a fitting attached to the heat exchanger portion of the invention. Then the refrigerant gas is loaded into the invention through this fitting. This fitting is then closed off. This refrigerant gas must be Duracool™, a hydrocarbon refrigerant which is not ozone depleting. Duracool™ has similar (if not better) vapor vs. pressure characteristics than HFC 134a. This makes Duracool™ an ideal working refrigerant for this invention.

The PLC electrical control cables are then attached. A lithium battery is placed into the receptacle on the PLC to provide the initial power source to operate the refrigerant inlet control valves. A mechanical load is connected to the central power output drive shaft. The invention is now ready to operate.

Method of Operation:

The PLC contains a lithium battery and a large pseudo storage capacitor to provide initial power to operate the refrigerant inlet control valve stepper motors. This auxiliary power source must be capable of operating the PLC and stepper motors for a minimum of 25 seconds, providing enough time to start the heat engine. After the heat engine is operating, (central output power shaft is rotating), a permanent magnet dynamo type electrical generator provides operating power to the PLC. The PLC uses a 1-Wire™ network to control the invention, determine the status of the invention, and to detect and control the various planned peripheral devices for the invention.

In the prototype of the invention, butane fuel is supplied from a cartridge placed into a gaseous input receptacle on the invention mounting plate. The PLC tests the fuel pressure via the 1-wire network. If fuel is available, the PLC opens the fuel inlet valve allowing a small amount of fuel to progress into the burner. As the fuel passes the burner inlet the fuel velocity causes ambient air to mix with the fuel. The PLC then generates a spark to ignite the fuel in the burner ring using a piezo-transformer. This sequence may be repeated up to six times, at which time a definite temperature rise must be detected by the thermal sensor embedded into the heat collector. If no heat is available the PLC lights the low fuel fault indicator, and then the PLC enters sleep mode to conserve power. If the low-fuel condition has not been corrected within 5 minutes, the PLC will shut down and enter the OFF state. At this point, it will not attempt to restart without additional operator intervention.

Once the PLC has detected the availability of a minimal threshold of heat (40 degrees F. temperature rise at the heat collector), the heat engine rotational start-up sequence begins. The PLC checks the angular displacement of the central power output shaft to determine which probe of the oscillator is at the peak of its travel. Next, the PLC commands the appropriate refrigerant inlet control valve rod to rotate one full revolution (360 degrees). As the refrigerant inlet control, valve rod rotates, 4 droplets of liquid refrigerant are moved into proximity of the heat collector. The refrigerant droplets absorb heat energy and boil into a vapor. The temperature of the heat collector determines the pressure of this refrigerant vapor.

The refrigerant vapor then fills the conduit, which communicates with the oscillator cavity. Expansion of the refrigerant vapor then forces the oscillator probe to retract. This causes the entire oscillator to move within the oscillator chamber. This motion of the oscillator applies force to the eccentric pin on the central power output shaft, causing it to rotate. This rotational energy is then available to drive an external load.

As the oscillator probe retracts, the tip of the oscillator probe moves far enough to expose the expiring vapors to an exhaust port for this quadrant. The remaining refrigerant vapor pressure is relieved as the refrigerant progresses into the exhaust port buffer area and onward to the vacuum created by the vapor pump. The cone vapor pump compressor uses a ball which is powered by centrifugal force pushing the refrigerant before it. The refrigerant, which condenses into liquid as it, travels through the waste heat exchanger, whereupon the liquid refrigerant then returns to the B1 plate via conduit re-entering the pre-evaporation refrigerant storage cell. The refrigerant cycle is completely enclosed within the gas-tight sealed portion of the invention, progressing through a continuous repetitive cycle of evaporation, expansion, compression, and condensation.

This operation is repeated inside each of the four quadrants of the oscillator cavity in the following binary order: 00-01-10-11. Actuation of each refrigerant inlet control valve is timed and controlled by the PLC to admit a droplet (or multiple droplets) of refrigerant just as the oscillator probe passes the appropriate position to allow the most efficient expansion of the refrigerant.

The refrigerant inlet control rods are able to dispense from one to sixteen droplets of liquid refrigerant to produce the vapor pressure necessary to drive the load. 16 droplets are dispensed by four complete 360-degree rotations of the valve. This sequence is completely controlled by the PLC. Because each power cycle only begins when the appropriate refrigerant inlet rod rotates, any fault, malfunction, or unforeseen event that prevents the PLC from operating results in immediate “power-down” condition of the central power output shaft, protecting the invention and its load from any damage that might be caused by excessive rotational speed.

### CONCLUSIONS

On this basis the invention will continue operation, until it is instructed to stop or fuel is exhausted, producing work efficiently, nearly silently, smoothly, and reliably. There are no known maintenance requirements of the invention at this time. The extremely hard and low-friction surfaces of the internal moving parts require no lubrication. The only mechanical part subject to wear is the main support bearing for the central power output shaft. This surface, once prepared to an AA finish, as is this area of the power shaft, establishes a so-called glass-on-glass interface, which is virtually friction-free assuring the possibility of extremely long life. There are no reciprocating internal parts to excessive vibration or wear. Motion of the oscillator produces only a very small vibratory moment due to its relatively low mass. Also, because there are four to six power pulses of expanding refrigerant per 360 degree rotation of the central power output shaft, there is no need for a large or heavy flywheel to smooth the rotational velocity of the power output shaft. The design contains a self-evacuation feature, as each probe tip travels to it topmost travel the exhaust port for that quadrant is exposed to the internal area of the oscillator, allowing the area to be vacuumed by the cone-pump action into the flow of the fluid, therefore nearly all vapor that may leak is contained within the device by various negative atmosphere operations which serve to protect the internal integrity of the device.

The advantages of this invention are manifest: With the herein-described invention energy is converted into motion with high efficiency and with great reliability. The refrigerant cell is extremely simple in construction and can readily be manufactured at an economical cost, due its construction from a number of individual flat plates. The PLC contains programming to switch easily from one heat source to another. As a result, this invention can use any one of a number of convenient and efficient methods of “external” fuel combustion as its heat source. Slow complete combustion with the aid of a multi-flame burner matrix can produce a nearly smokeless burn with conventional fossil fuels. Carbon-free fuels such as hydrogen may be used in the burner. A method of operation that is totally non-global warming is available by using the infrared component of regular sunlight as the heat source. Changes in specification and form of this invention as herein described may be made within the scope of what is claimed, without departing from the spirit of the invention.

1) A heat engine formed from a group of stacked plates formed from Advanced Ceramics such as z500 & z900 mold-able ceramics from Morgan Advanced Ceramics, utilizing Duracool, Hydrocarbon based refrigerant as the working fluid.

2) A heat engine with rotary control valves operated by a PLC and special stepping motors.

3) A heat engine with a heat input block on one end and a heat exchanger on the other end where all mechanical components are completely contained within one structure (i.e. no external liquid or gas pipes similar to internal combustion engines).
